(19) United States
(12) Patent Application Publication
(10) Pub. No.: US 2007/0042329 A1
(43) Pub. Date: Feb. 22, 2007

(54) Personal organizer method and system

(76) Inventors: Diane Curtin, Racine, WI (US); Stacy L. Curtin, New York, NY (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/206,535

(22) Filed: Aug. 18, 2005

(51) Int. Cl. G09B 19/18

(52) U.S. Cl. 434/108

(57) ABSTRACT

A method and system provides a unique data display tool for use in acquiring and storaging personal educational or vocational information. The method and system utilizes road map-like analogies to guide the user through a number of displays, each of which is intended to provide information and guidance to the user for acquiring information, for knowing where to look for the information, and what to do with it once acquired. The method and system also provides a number of checklists and abbreviated shortcuts to aid the user in the complete and accurate acquisition of important information. In the preferred embodiment of the method and system, the tool is tailored to use by high school students, parents and guidance professionals to assist students in the process of successfully completing high school as well as preparing for life after high school.

### FIELD OF THE INVENTION

This invention relates generally to methods and systems for acquiring, organizing, storing, processing, retrieving and displaying information and data. More specifically, it relates to a method and system that prompts the user to consider the acquisition of certain specific information and data that is relevant to the user's educational and vocational career options and experience and, once considered and/or acquired, to organize that information and data in a particular format. It also relates to such a method and system that uses electronic storage media and hard copy storage, each storage method complementing the other. It also relates to such a system and method whereby data and information is quickly and readily available to, and assimilated by, the user once acquired. It also relates to such a system and method that utilizes a “road map” organizing methodology where the subject matter is identified by street sign names and other “road map” analogies to aid the user in navigating through the system.

### BACKGROUND OF THE INVENTION

Perhaps more than ever before, individuals in our society are inundated with tremendous amounts of information from a seemingly endless number of sources and through a variety of different media. Some of that information is useful, some not. Certain of that information is, however, necessary for us to advance our educational and vocational goals. Sifting through all of that information is only one aspect of acquiring useful information. The other aspect of acquiring useful information is recognizing what information is truly useful and where that information can be found. Indeed, in the experience of these inventors, the acquisition and retention of truly useful information is a daunting task, particularly when it comes to the information that is truly relevant and quite essential for the success of one's educational and vocational experiences.

As a student advances through his or her school years, there is much essential and useful information that should be retained for future use. While that information may be retained in some fashion or another, it typically is not retained in any particular location or in accordance with any particular format. Perhaps all of that information is simply tossed into a single folder or into a single drawer, and in somewhat of a “last in, first out” fashion, and in no other particular order. This provides the user with no useful system of organization and makes retrieval of that useful information very difficult, at best.

Perhaps even more problematic is the fact that many students, and their parents, simply fail to recognize that certain information should be sought out or obtained in the first instance. In the area of educational and vocational endeavors, it is difficult for many students or their parents to approach the subject of information acquisition and information retention in a systematic and generally “linear” fashion. That is, while most students and their parents have some vague idea as to what is and what is not important to the goal of advancing the student's educational and job-search endeavors, many students and their parents tend to approach the subject in a rather “hit and miss” or a substantially “non-linear” fashion.

In the view of these inventors, what is needed is a systematic approach to a student or parent user's acquisition and retention of important and relevant educational and vocational information for that student. To be useful, the method and system should provide a carefully and thoughtfully formatted, step-by-step approach to the subject, the approach being presented in a “user-friendly” fashion such that the student and/or the student's parents will be guided through a pre-programmed scheme that “prompts” the user to acquire certain information. The method and system should be helpful in presenting solutions to certain issues raised and it must also be sensitive to issues of timing and subject matter, with the method and system explaining when certain steps must be taken by the student and when. What is also needed is such a method and system that is both comprehensive in scope and thought-provoking in application. The method and system should intuitively guide the student and/or his or her parents through the method and system by providing for appropriate electronic and hard copy prompting of such useful information. The method and system should also provide for electronic and hard copy storage and display of the acquired information for later use.

### SUMMARY OF THE INVENTION

In the view of these inventors, the method and system of the present invention has obtained these objects. The method and system of the present invention is a unique data acquisition and storage tool for use in the areas of education and vocation. It aids the user in the assimilation of that information. It also aids the user by indicating when certain steps must be taken by the student and when. More specifically, the method and system of the present invention is a self-directed, easy-to-follow guide for parents, teachers, mentors and students to help students get a successful start as they begin their journey in life. Key components of the method and system are documentation and filing. These aspects combined with understanding the educational process will help students successfully plan for the future. The method and system of the present invention includes a planning guide to help student develop life skills. Included are self-directed instructions and samples of important documentation for storing and updating as life changes for the user.

In a preferred embodiment that implements the method and system for use by high school students, their parents, teachers and mentors, a “road map” of sorts is provided. This so-called “road map” is a tool that provides students with options for “crash courses” in certain areas, with options for “short cuts” in other areas, and with options for “test runs” in yet other areas. It also provides certain “power points” at certain points throughout the system. More specifically, “crash courses” are quick lessons that are contained in certain sections of the system that address that section in an abbreviated format. “Short cuts” are quick tips and “test runs” are examples that are shown before the particular activity is actually tried by the user. Finally, “power points” are opportunities used within the system to afford the user with an opportunity to stop and think about a topic, to invite the user to try it himself or herself, or to easily retrieve information from the system. All of this is accomplished in a way that is analogous to navigating city streets and with the theory that if we know where we are, and can recognize street signs and landmarks, then we know where we are going, or at least be more confident that we are going in the right direction. “Power points” are used in this analogy as opportunities to “re-fuel” and so on. It should also be mentioned that these inventors have coined the name ROAD TRIP™ as a trademark for the method and system disclosed herein and have applied for protection of that name with this Office.

The foregoing and other features of the method and system of the present invention will become apparent from the detailed description that follows.

### BRIEF DESCRIPTION OF THE DRAWINGS

FIGS. 1-3 are exemplary data displays of the type that may utilize the method and system of the present invention.

FIG. 4 is a perspective view of a storage box of the type that would be used with the method and system of the present invention.

FIGS. 5-60 are other exemplary data displays of the type that may be used with method and system of the present invention.

### DETAILED DESCRIPTION

As previously mentioned, the method and system of the present invention is a unique data acquisition and storage tool for use in the areas of education and vocation that aids the user in the assimilation of information. To a great extent, the method and system of the present invention is self-directed and provides an essential planning guide to help the user develop certain life skills. One such life skill is organization itself. The method and system of the present invention is presented in a “road map” analogy wherein “counties” of topics are presented, as are specific “avenues”, “lanes” and other identifiers that are commonly used in navigating the road map, much as one would use a regular road map to find his or her way from one point to another point, typically a starting point and an ending point on a journey.

In this detailed description, the particular embodiment discussed applies the method and system of the present invention to a high school setting, for use by a high school student or by his or her parents and counselors. It is to be understood, however, that the method and system could equally be adapted for use for at the pre-high school, college and even post-graduate levels. It could also be adapted for use as a system for purely vocational purposes. The preferred embodiment and application, however, exists at the high school and college levels.

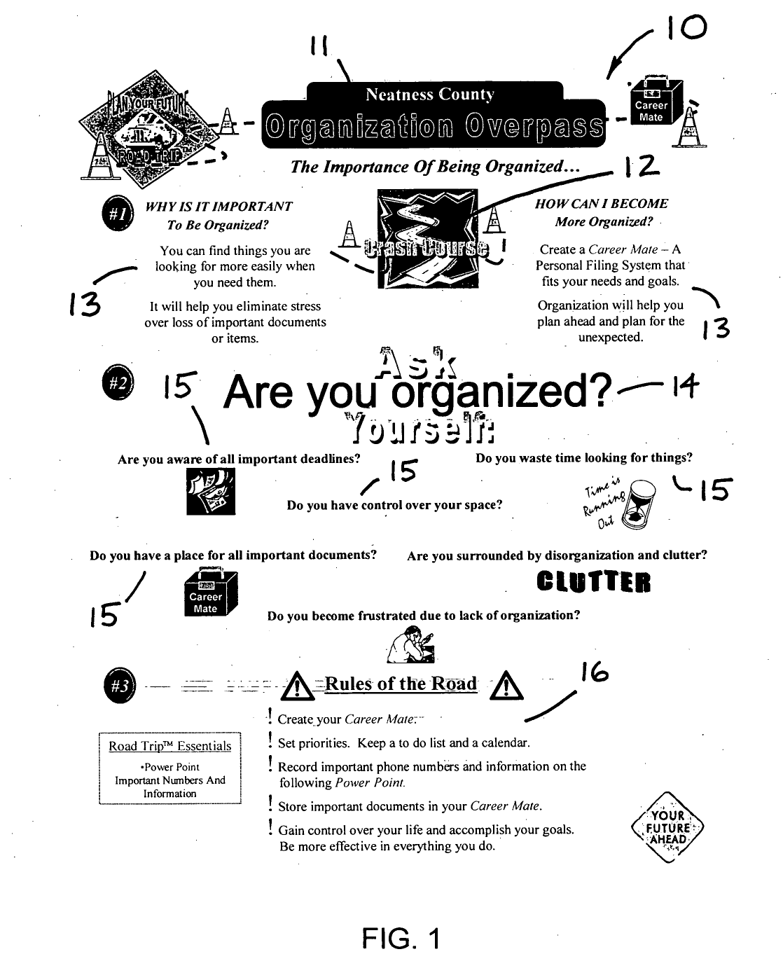

Referring now to the drawings in detail wherein like numbers represent like elements throughout, FIG. 1 illustrates a sample of a two-dimensional display, generally identified 10, used with the system and method of the present invention as applied in a high school setting. In form, it is to be understood that the display 10 could be presented to the user in a hard copy format as well as a screen display, or both. In substance, the display 10 includes the outline 11 of a “road sign” at the upper-most portion of the display, the road sign identifying “Organization Overpass” which, by “road map” analogy, is located in “Neatness County.” This display 10 is presented in the form of one of several “Crash Courses” that are presented in the method and system of the present invention. The particular “Crash Course” 12 contained in this display 10 is a three-part inquiry that addresses the topic of “The Importance of Being Organized.” The first part 13 of this “Crash Course” 12 tells the user why it is important to be organized and how he or she can become better organized. The display 10 asks the user the very fundamental question 14, “Are you organized?” Several follow-up questions 15 are used to probe into the user's habits concerning organization, including the questions “Are you aware of all important deadlines?”; “Do you waste time looking for things?”; “Do you have control over your space?”; and “Do you have a place for all important documents?” This last question 15 is tied into a major aspect of the method and system of the present invention, which is to provide a physical and centralized “place” for the user to keep those important documents. This place is, in the preferred embodiment, identified as the user's “Career Mate.” The significance of the “Career Mate” concept will become apparent later in this detailed description. The display 10 also includes certain introductory “Rules of the Road” 16 which are basic instructions for organization, including “Set priorities” and “Keep a to do list and a calendar.”

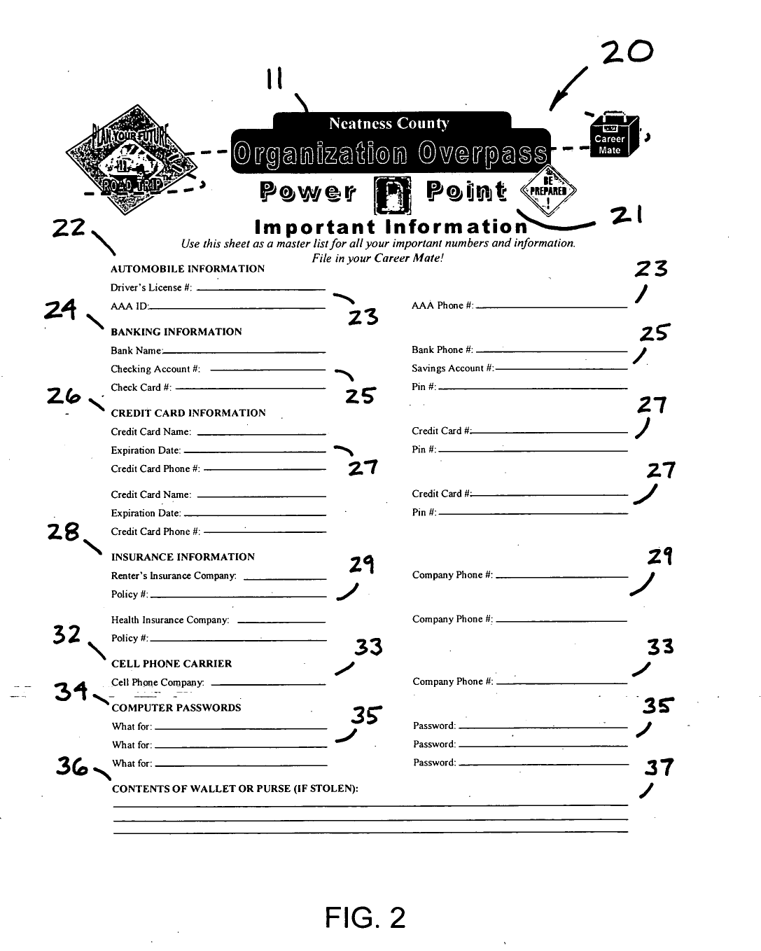

FIG. 2 illustrates a sample of another two-dimensional display, generally identified 20, used with the system and method of the present invention. In form, it is similarly understood that the display 20 would be presented to the user in a hard copy format as well as a screen display. This display 20 also includes the outline 11 of a “road sign” at the upper-most portion of the display, the road sign identifying “Organization Overpass” which, by “road map” analogy, is located in “Neatness County.” This road sign analogy serves to tell the user that the displays 10, 20 of FIGS. 1 and 2, respectively, are closely related. This display 20 is also formatted as a “Power Point” 21 in that it reminds the user to use the display 20 as a “master list” for important numbers and information, the notion of a “Power Point” 21 being a check-point prompting the user to take action by completing the provided worksheet and filing it in a “Career Mate” for easy retrieval, updating and reference. The display 20 includes “prompting” areas for the insertion of certain important and organizational information such as “Automobile Information” 22; “Banking Information” 24; “Credit Card Information” 26; “Insurance Information” 28″; “Cell Phone Carrier” identity and contact information 32; “Computer Passwords” 34; and “Contents of Wallet or Purse (If Stolen)” 36. Each prompt 22, 24, 26, 28, 32, 34, 36 includes corresponding spaces 23, 25, 27, 29, 33, 35, 37, respectively, for the entry of important information that is relevant to the user. Each space 23, 25, 27, 29, 33, 35, 37 may be completed by handwritten notation on the hard copy format or by keying in the information in the electronic screen display format.

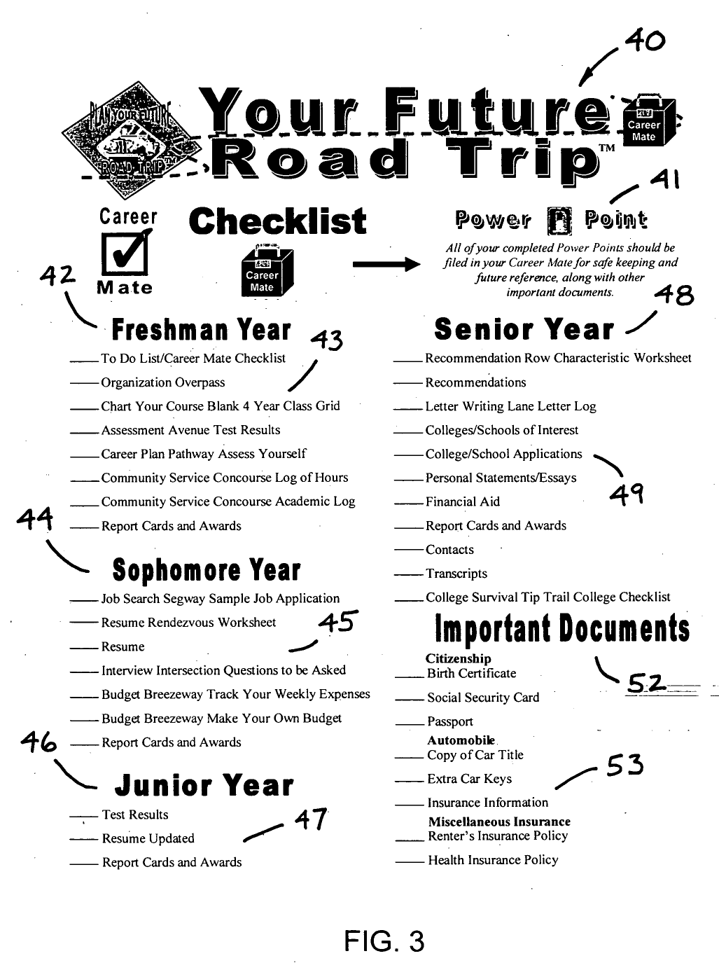

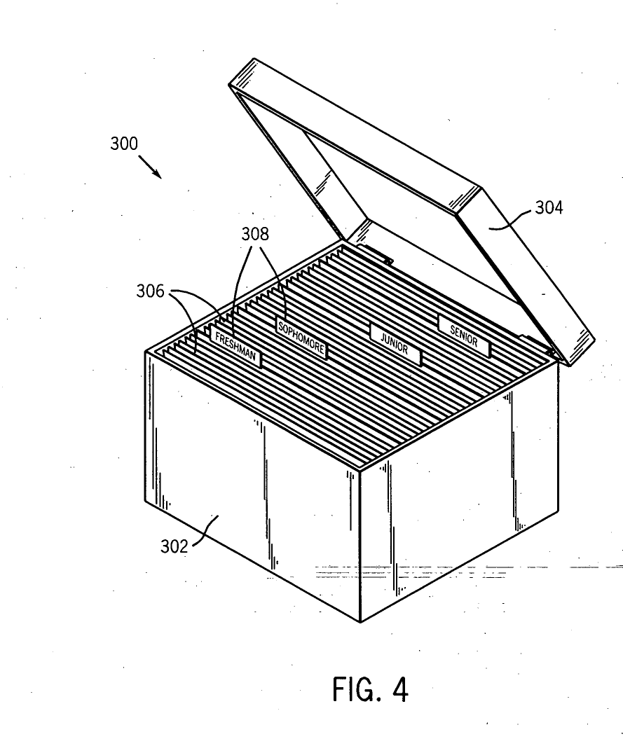

FIG. 3 illustrates a sample of yet another two-dimensional display, generally identified 40, used with the system and method of the present invention. In form, it is similarly understood that the display 40 would be presented to the user in a hard copy format as well as a screen display. The display 40 includes a “prompting” checklist of various areas that are relevant to each of the user's high school years 42, 44, 46, 48 and an area for “Important Documents” 52 that are generally relevant, regardless of the user's grade level. This display 40 is also formatted as a “Power Point” 41 in that it reminds the user to file all completed “Power Points” 41 in his or her “Career Mate” for safe-keeping and future reference. This “Career Mate” is a physical portable file box and hanging file array. Such an array is shown in FIG. 4 which illustrates a preferred embodiment of a portable box assembly, generally identified 300, that includes a box-like base 302, a hinged cover 304, and a plurality of hanging files 306, each containing an appropriate tab or label 308 attached to it. It is to be understood that the exact size and style of box assembly 300 is not a limitation of the present invention and that a variety of boxes, with and without covers, could be used without deviating from the scope of the present invention.

The information placed on each tab or label 308 is determined substantially in accordance with the checklist display 40 identified above. By way of example, the “Freshman Year” 42 labels would be identified in accordance with the sub-checklist 43 that includes “To Do List”; “Organization Overpass”; “Chart Your Course Blank 4 Year Class Grid”; “Assessment Avenue Test Results”; “Career Plan Pathway Assess Yourself”; “Community Service Concourse Log of Hours”; “Community Service Concourse Academic Log”; and “Report Cards and Awards.” Though not specifically illustrated in FIG. 4, it is to be understood, however, that all topics identified throughout this detailed description could be used as a separate file folder 306, such file 306 having its own corresponding label or tab 308.

Similarly, the “Sophomore Year” 44 labels would be identified in accordance with the sub-checklist 45 that includes “Job Search Segway Job Application”; “Resume Rendezvous Worksheet”; “Resume”; “Interview Intersection Questions To Be Asked”; “Budget Breezeway Track Your Weekly Expenses”; “Budget Breezeway Make Your Own Budget”; and “Report Cards and Awards.”

The “Junior Year” 46 labels would be identified in accordance with the sub-checklist 47 that includes “Test Results”; “Resume Updated”; and “Report Cards and Awards.” Being a transitional year from high school to college and requiring the accumulation of critical decision-making information, the “Senior Year” 48 labels would be identified in accordance with the sub-checklist 49 that includes “Recommendations Row Characteristics Worksheet”; “Recommendations”; “Letter Writing Lane Letter Log”; “Colleges/Schools of Interest”; “Colleges/School Applications”; “Personal Statements/Essays”; “Financial Aid”; “Report Cards and Awards”; “Contacts”; “Transcripts”; and “College Survival Tip Trail College Checklist.”

It should also be mentioned here that the freshman, sophomore, junior and senior checklists identified above are a course to “travel” and is an overall guide to the high school “journey.” However, it is to be understood that any section can be pulled or retrieved by the user as an individual lesson for that student, irrespective of the student's grade level. For example, a student beginning the process as a junior could review important elements presented during freshman and sophomore years, and so on. In short, the system of the present invention provides a flexible solution to the challenges faced by any student and regardless of his or her grade level. Sections can be re-visited by the student as needed, the system being dynamic in its presentation and in its problem-solving capabilities. The system is easily navigable, and it is intended to be that way. While all of the “landmarks” are there to be followed, the exact journey followed by any one student may be entirely different from that of another student, as that student's needs are filled by the comprehensive system presented here and his or her ability to visit and re-visit sections as desired or required.

Finally, the “Important Documents” 52 labels that are not grade-specific would be identified in accordance with the sub-checklist 53 that includes certain citizenship documents including “Birth Certificate”; “Social Security Card”; and “Passport”; certain automobile documents including “Copy of Car Title”; “Extra Car Keys”; and “Insurance Information”; and certain miscellaneous insurance documents including “Renter's Insurance Policy”; and “Health Insurance Policy.” It should also be understood that this list can be supplemented by the user as is necessary to adapt this section to that student's particular needs or requirements.

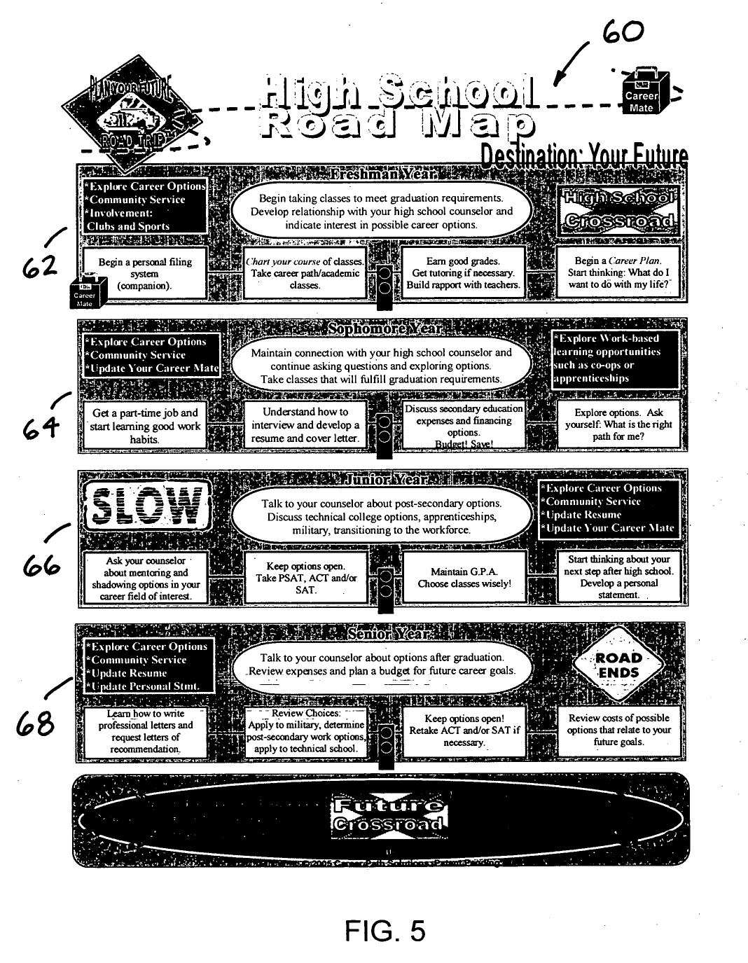

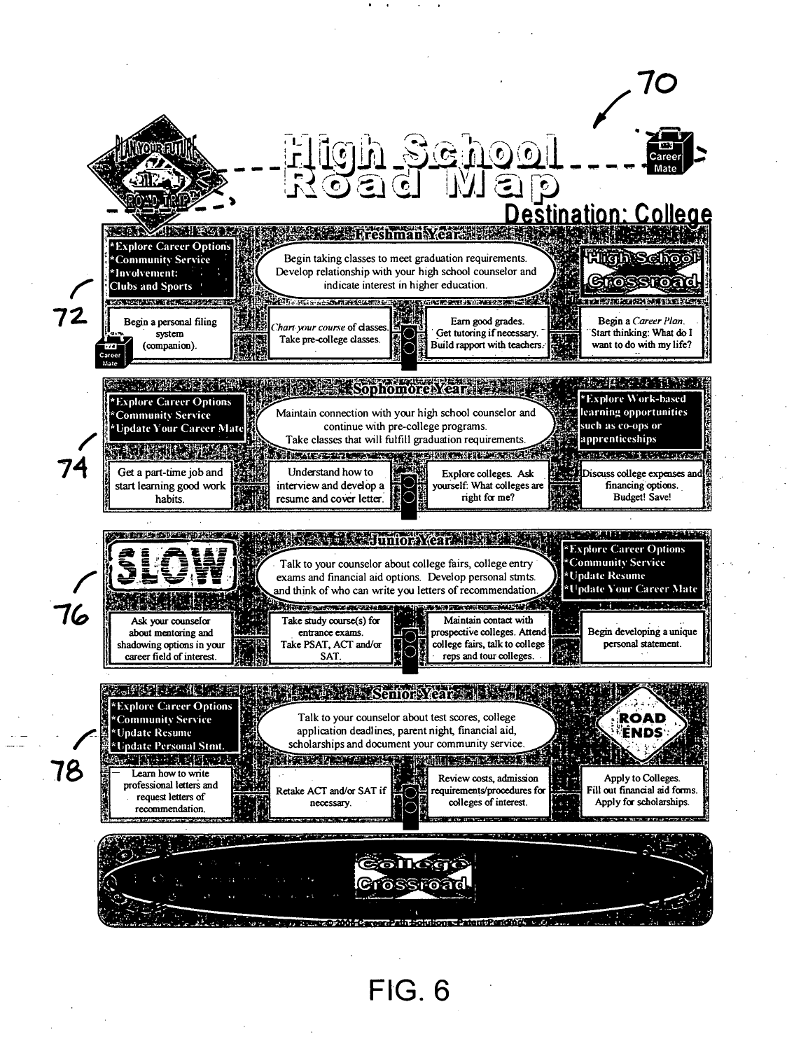

Referring now to FIGS. 5 and 6, each illustrates a “High School Road Map” display for non-college destinations 60 and college-bound choices 70, respectively. The non-college bound destination display 60 includes grade-sensitive and instructive considerations 62, 64, 66, 68 that are to be reviewed by the user. The college-bound display 70 includes similar instructive considerations and thought-provoking suggestions 72, 74, 76, 78. As with the other displays, the “Road Map” displays 60, 70 are reviewable via both hard copy and electronic screen display.

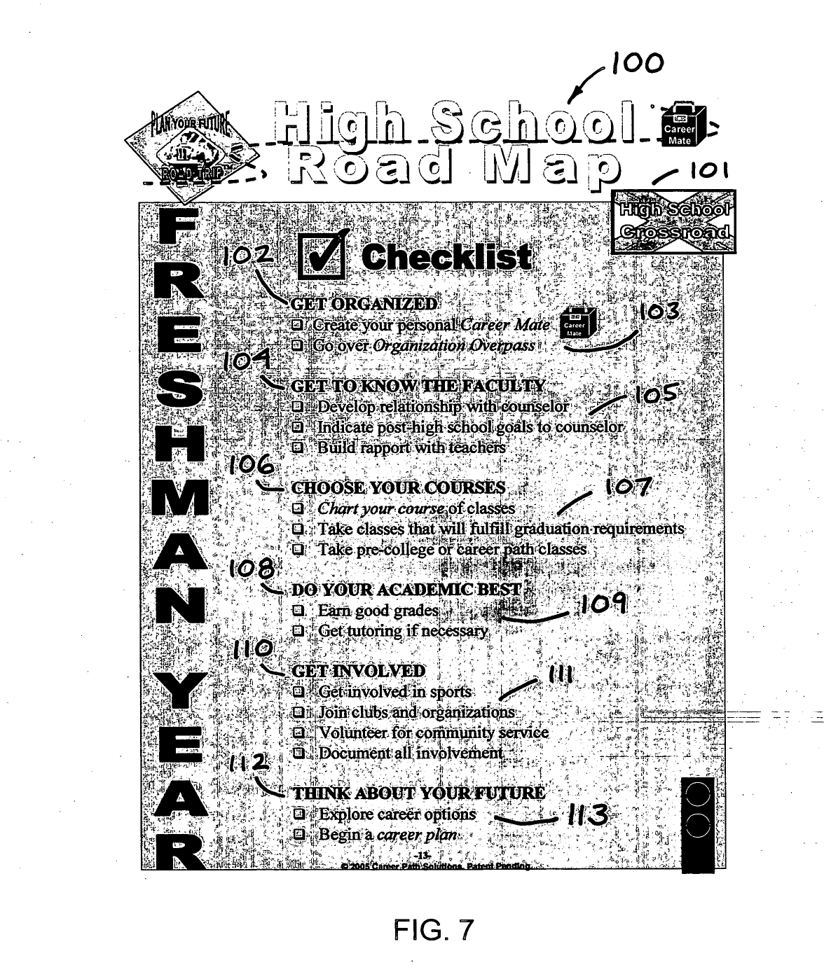

Referring now to FIGS. 7, 8, 9 and 10, each illustrates a display 100, 120, 140, 160 that includes a checklist for each of the freshman, sophomore, junior and senior years, respectively. It is to be understood that each display could be the first page in a set of displays that are grade and year sensitive. It is also to be understood that each checklist is grade-sensitive in the information and topics identified. For example, the freshman year checklist 100 shown in FIG. 6, which checklist 100 is appropriately cued by the road sign “High School Crossroad” 101, contains certain categories for “Get Organized” 102; “Get to Know the Faculty” 104; “Choose Your Courses” 106; “Do Your Academic Best” 108; “Get Involved” 110; and “Think About Your Future” 112. Below each category 102, 104, 106, 108, 110, 112 are a number of sub-categories 103, 105, 107, 109, 111, 113, respectively. The sophomore year checklist 120, which checklist 120 is appropriately cued by the road sign “Drive” 121, contains certain categories for “Interaction With Faculty” 122; “Course Choices” 124; “Explore Career Opportunities” 126; “Get Organized” 128; and “Start Budgeting” 130. Below each category 122, 124, 126, 128, 130 are a number of sub-categories 123, 125, 127, 129, 131, respectively. The junior year checklist 140, which checklist 140 is appropriately cued by the road sign “Slow” 141, contains certain categories for “Ask Your Counselor About” 142; “Post-Secondary Preparation” 144; “Your Academic Best” 146; “Involvement” 148; “Your Future” 150; and “Budget” 152. Below each of these categories 142, 144, 146, 148, 150, 152 are a number of sub-categories 143, 145, 147, 149, 151, 153, respectively. Finally, the senior year checklist 160, which checklist 160 is appropriately cued by the road sign “Road Ends” 161, contains certain categories for “Ask Your Counselor About” 162; “Post-Secondary Preparation” 164; “Continue . . . ” 166; and “Budget” 168. Below each category 162, 164, 166, 168 are a number of sub-categories 163, 165, 167, 169, respectively.

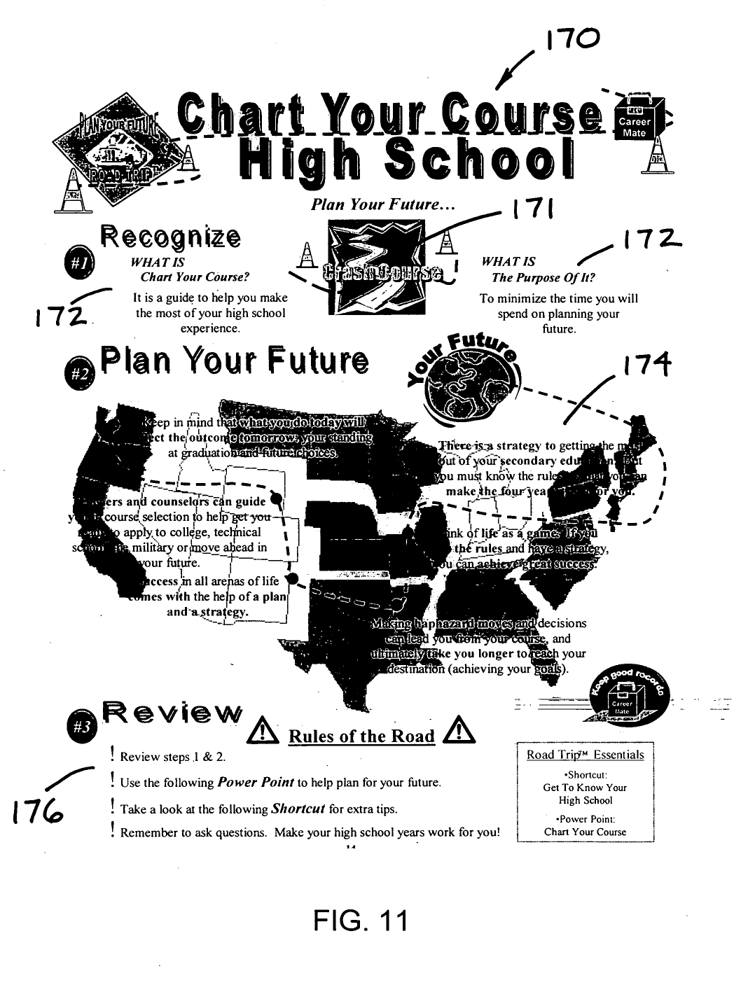

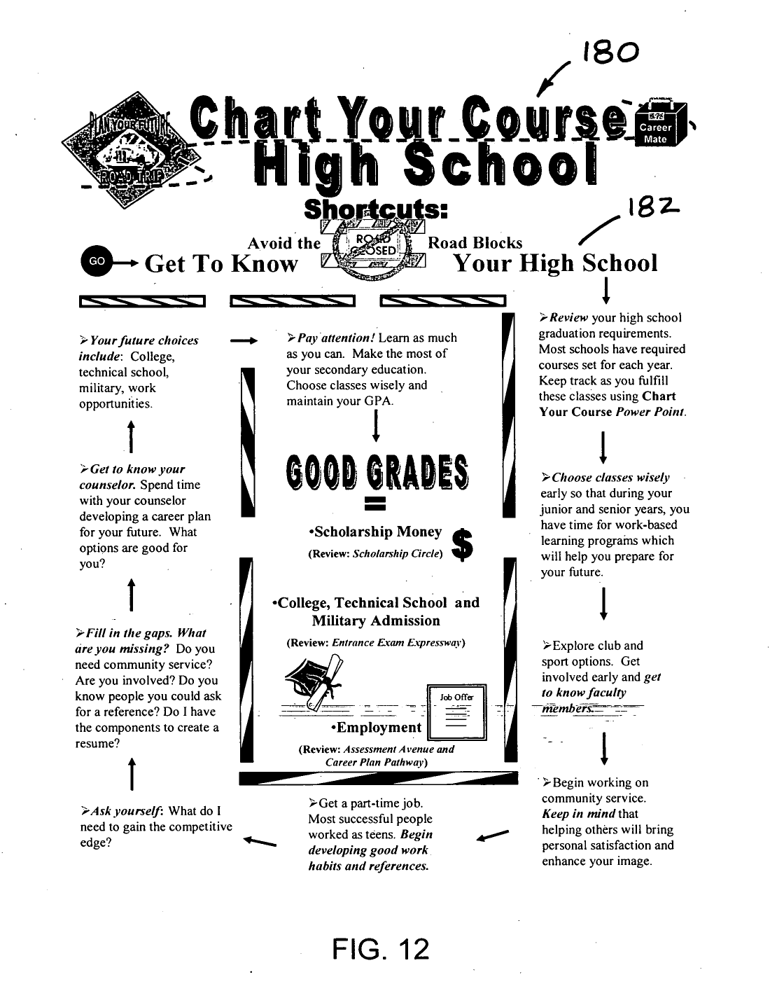

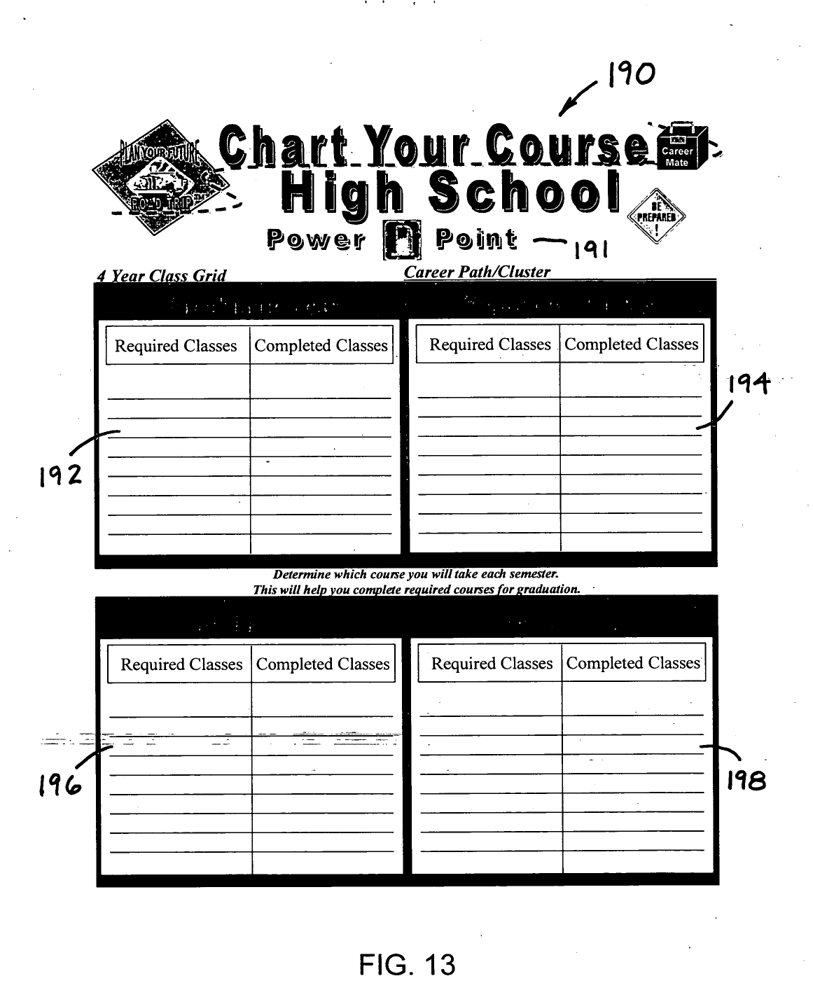

FIG. 11 illustrates another two-dimensional display 170 of a three-step “Crash Course” 171 analysis for the user to “chart” his or her course through high school. In the preferred embodiment, this display 170 would follow the display 100 shown in FIG. 7 as it relates to considerations that are to be made early on in the student's high school career. The user is effectively given a “crash course” for recognizing 172 what “Chart Your Course” is and what its purpose is. This display 170 also provides the user with a graphical guideline 174 to “Plan Your Future” and with a checklist 176 of “Rules of the Road.” Similarly, FIG. 12 illustrates a two-dimensional display 180 that would follow the previous display 170 with various suggested “Shortcuts” for avoiding high school “Road Blocks” 182. Among the suggestions 182 provided are “Choose classes wisely” and “Begin working on community service”, among others. Each suggestion 182 is intended to be a reminder and a thought-provoking tip for the user. Closely related to the display 180 of FIG. 12, is the display 190 that is illustrated in FIG. 13 which is a four-year class grid, asking for “Required Classes” and “Completed Classes” for the user's freshman 192, sophomore 194, junior 196 and senior 198 years. This display 190 is also formatted as a “Power Point” 191 in that it reminds the user to file the completed “Power Point” 191 in his or her “Career Mate” 300 for safe-keeping and future reference.

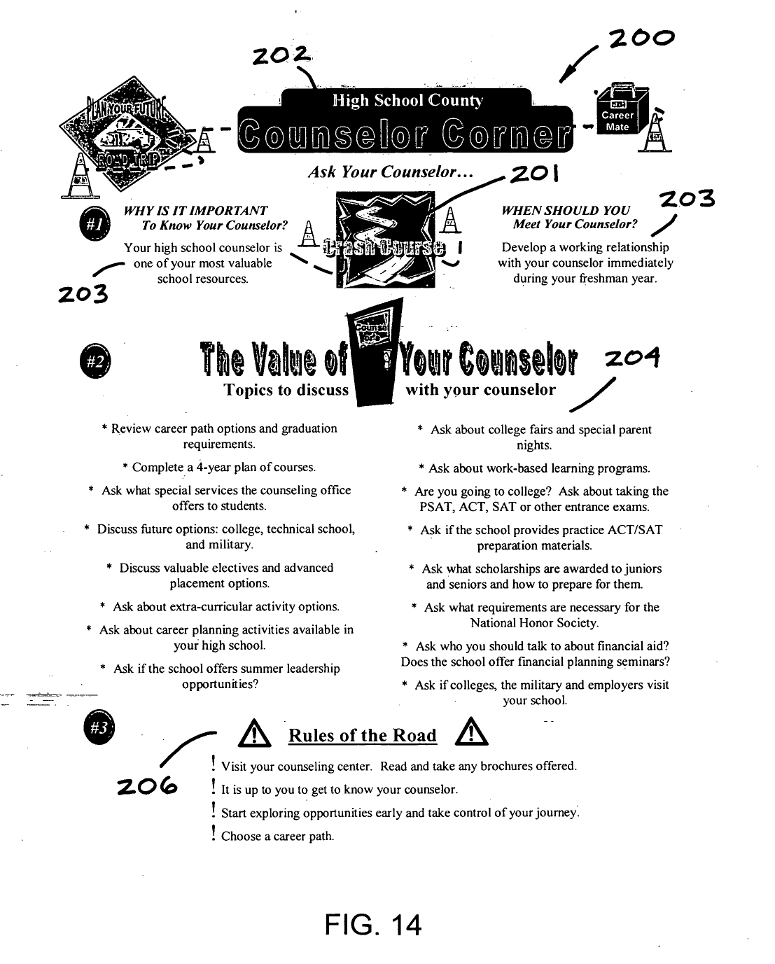

FIG. 14 is also related to the display of FIG. 12 in that it provides a two-dimensional display 200 in the form of another three-step “Crash Course” 201 for the purpose of having the student avail himself or herself of available guidance provided by the user's high school counselors. This display 200 includes the outline 202 of a “road sign” at the upper-most portion of the display 200, the road sign 202 identifying “Counselor Corner” which, by “road map” analogy, is located in “High School County.” This display 200 provokes the user to ask 203 why a counselor is important and when the counselor should be consulted. The display 200 also provides the user with a litany of topics 204 to be discussed with the counselor. As with other “Crash Course” components of the method and system of the present invention, display 200 provides certain “Rules of the Road” 206 to be followed as well.

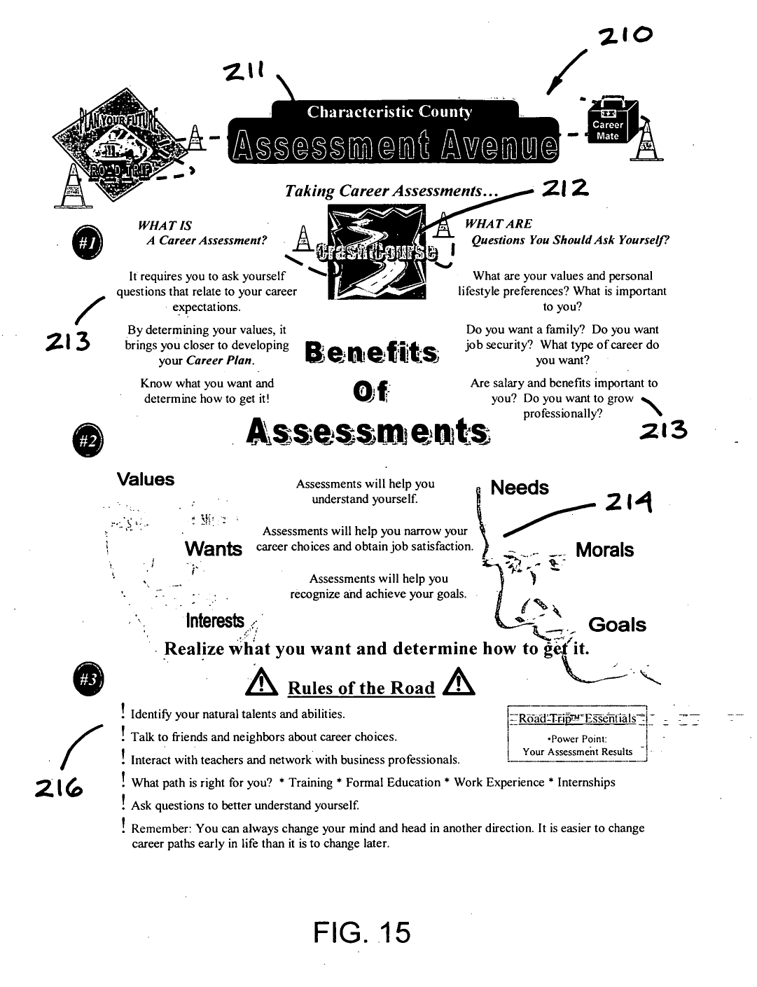

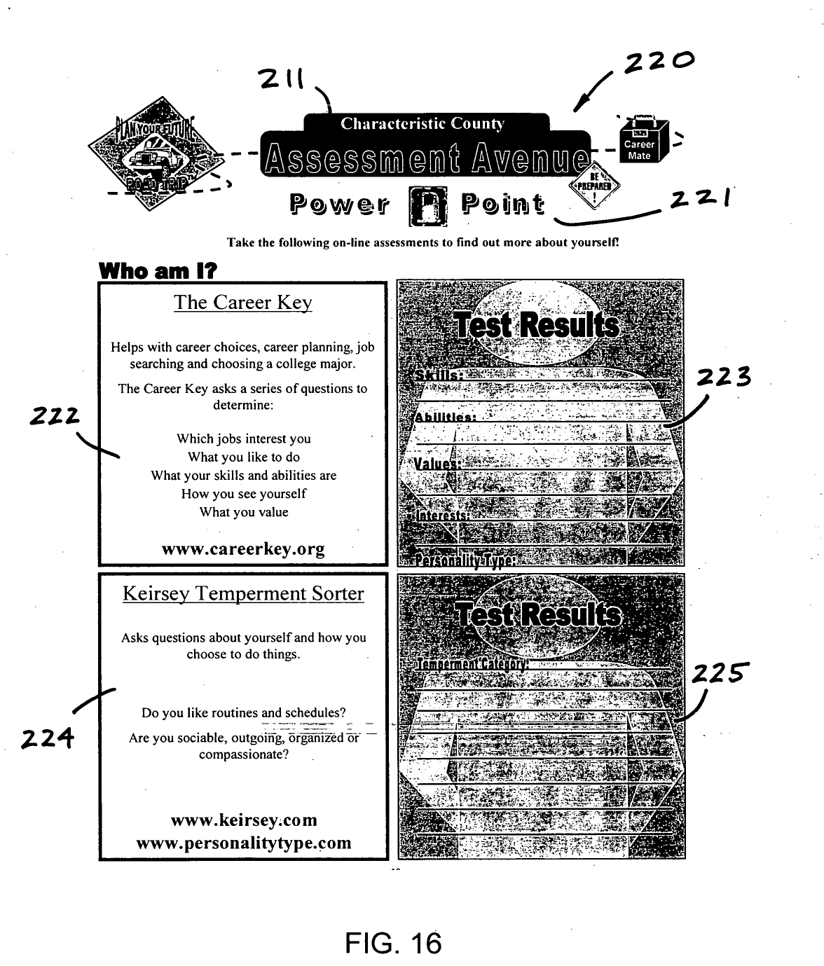

FIG. 15 is yet another display 210 that includes the outline 211 of a “road sign” at the upper-most portion of the display 210, the road sign 211 identifying “Assessment Avenue” which, by “road map” analogy, is located in “Characteristic County.” This display 210 is another three-part “Crash Course” 212 that relates to “Taking Career Assessments.” The display 210 first explains 213 what career assessment is and what questions the student should ask himself or herself. The second prong 214 of this “Crash Course” 212 directs the student to certain thought provoking introspection. The third prong directs the student to certain “Rules of the Road” 216 that are to be followed. The display 220 shown in FIG. 16 is closely related to the display 210 of FIG. 15 and bears the same road sign 211. It further identifies two specific assessments 222, 224 that can be made by the student and the test results 223, 225 realized from them. This display 220 is also formatted as a “Power Point” 221 in that it suggests that the user take the on-line assessment and to save the results in his or her “Career Mate” 300 for safe-keeping and future reference.

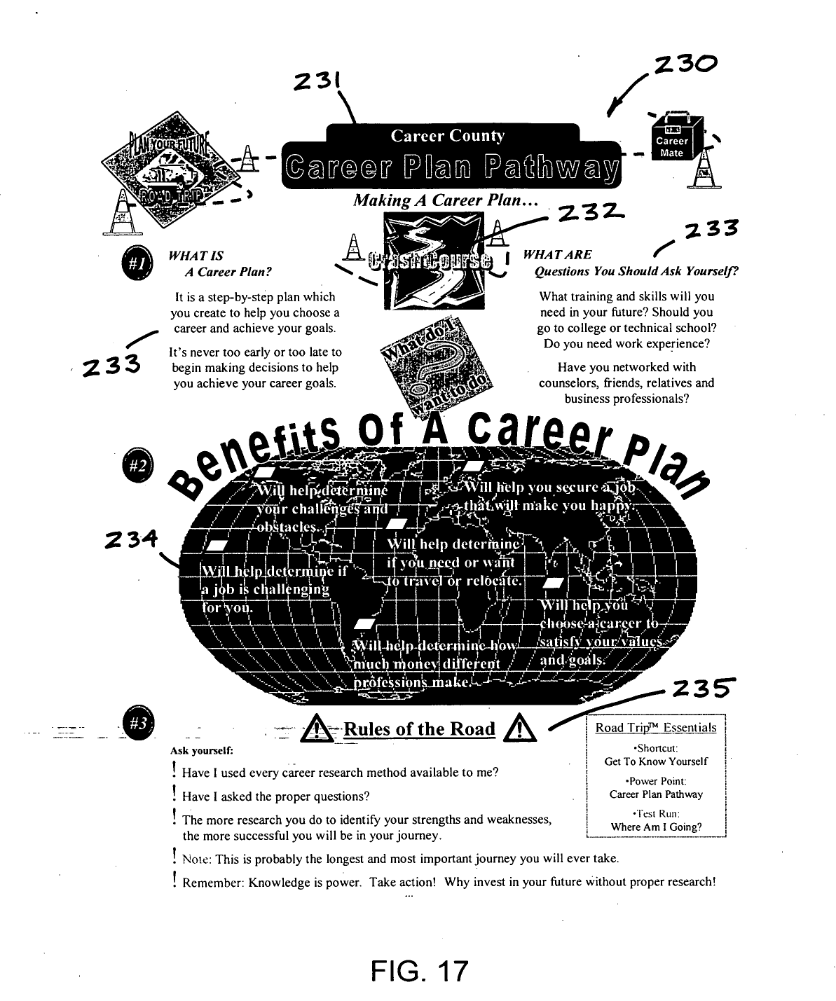

Referring now to FIG. 17, it illustrates a display 230 in the form of another “Crash Course” 232 and includes the outline 231 of a “road sign” at the upper-most portion of the display 230, the road sign identifying “Career Plan Pathway” which, by “road map” analogy, is located in “Career County.” This display 230 includes a section 233 that explains what a career plan is and what questions the user should ask himself or herself relative to his or her career plan. The second prong 234 of this “Crash Course” 232 explains to the student the benefits of having a career plan. The display 230 further identifies certain “Rules of the Road” 235 that are to be followed as well.

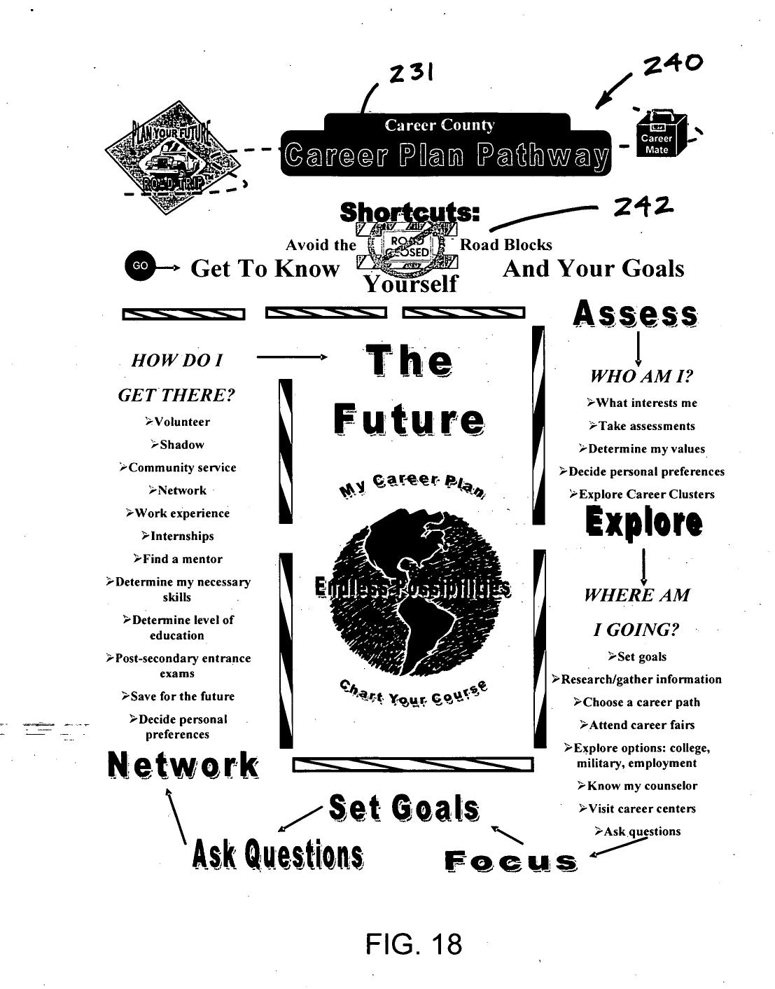

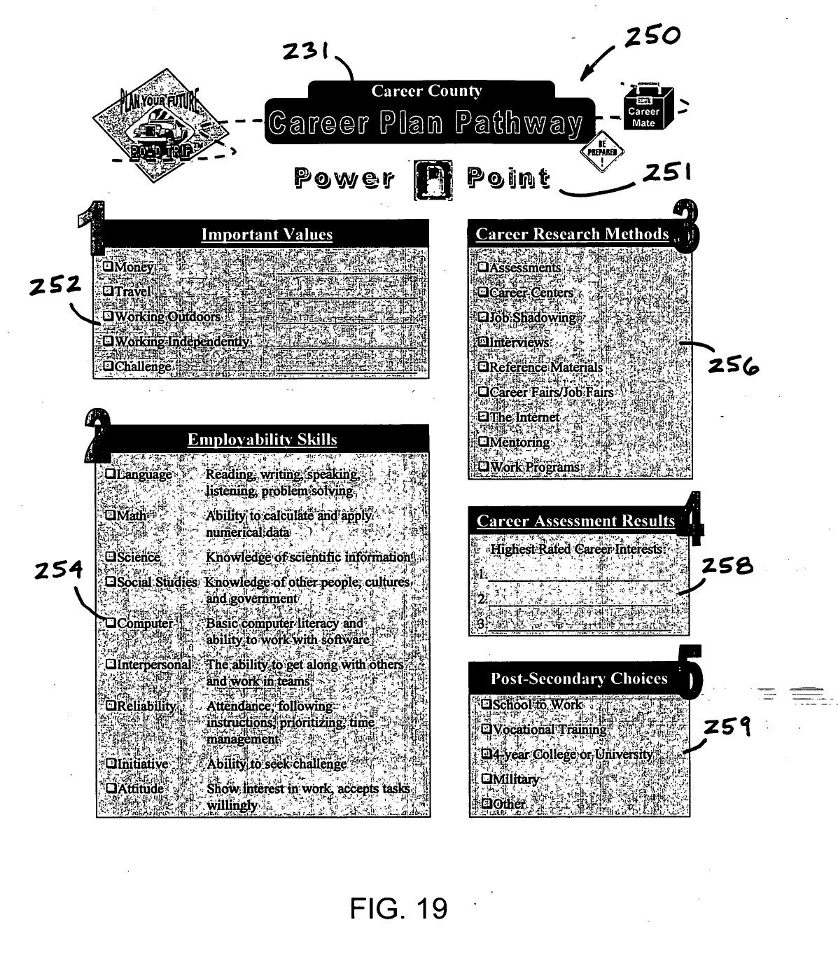

FIG. 18 illustrates a display 240 that is closely related to the display 230 shown in FIG. 17. The display 240 includes the same road sign 231 and includes certain shortcuts 242 for avoiding “Road Blocks” relative to the student's career plan. Closely related to the display 240 of FIG. 18, is the display 250 illustrated in FIG. 19 which is a five-step check list for certain items to be considered by the student. More specifically, the display 250 includes a section entitled “Important Values” 252; a section entitled “Employability Skills” 254; a section entitled “Career Research Methods” 256; a Career Assessment Results” section 258; and a “Post-Secondary Choices” section 259. Each section 252, 254, 256, 258, 259 includes certain items for consideration by the user. Also note that the road sign 231 is the same as that identified with displays 230, 240. This display 250 is also formatted as a “Power Point” 251 in that it reminds the user to filed the completed “Power Point” 251 in his or her “Career Mate” 300 for safe-keeping and future reference.

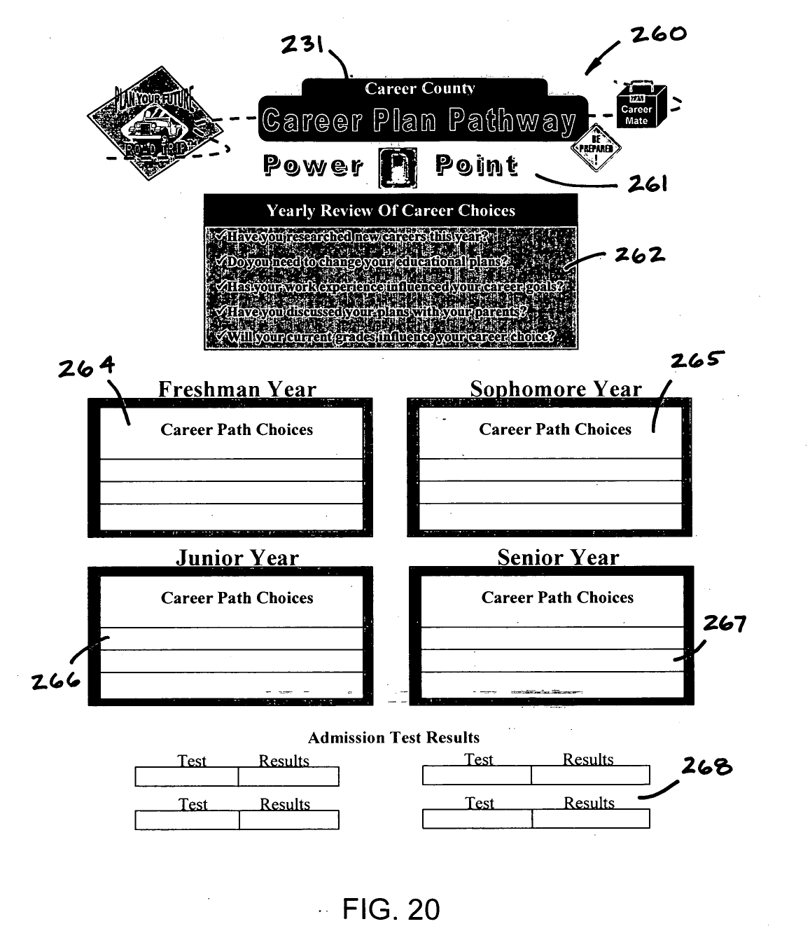

Closely related to the previous displays 230, 240, 250 is the display 260 illustrated in FIG. 20, that display 260 having the same road sign 231 as the prior displays immediately before it as shown in FIGS. 17-19 and also being formatted as a “Power Point” 261. The display 260 challenges the user to make a yearly review of his or her career choices by asking certain questions 262 and providing answer blocks 264, 265, 266, 267 for each year of the student's high school career. Additionally, the display 260 includes a section for entering admission tests taken and the test results realized 268.

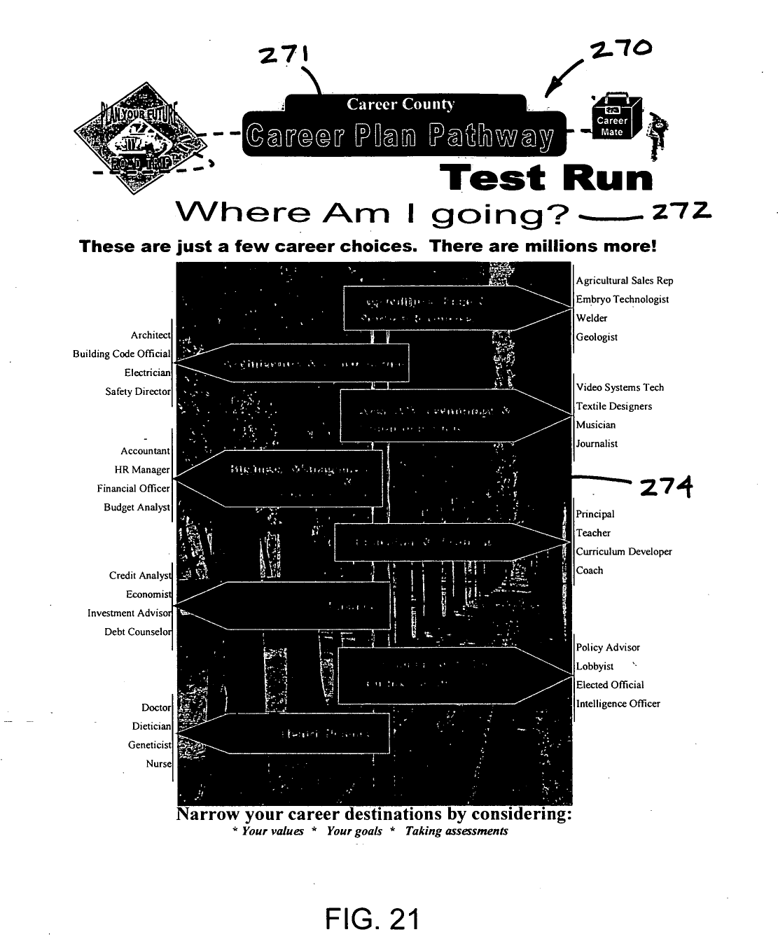

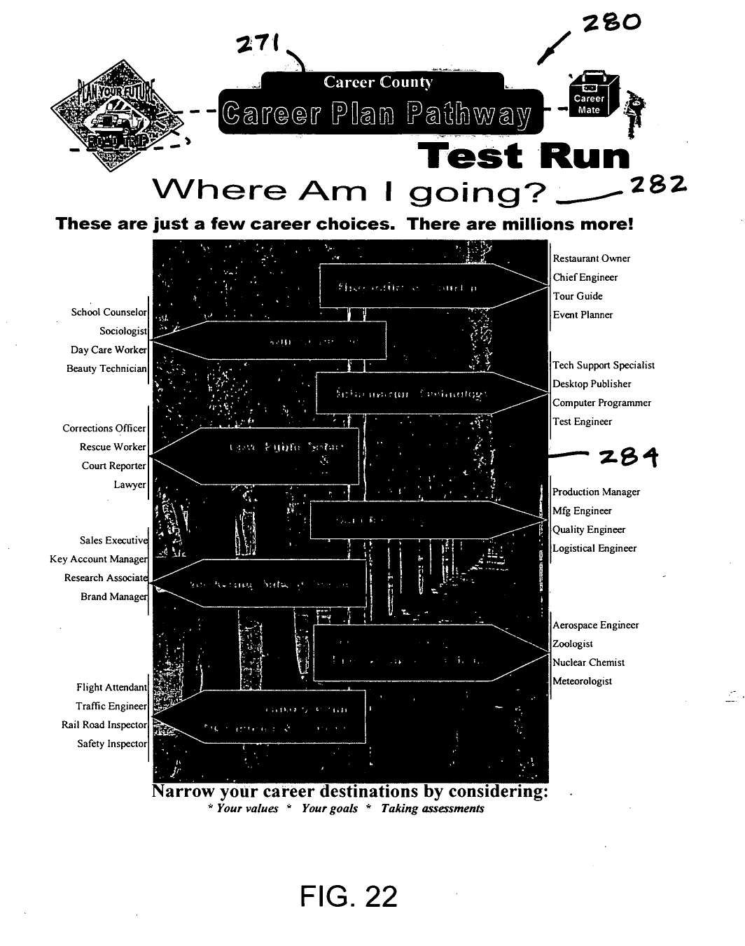

Referring now to FIGS. 21 and 22, the displays 270, 280 shown in those figures ask the student the question of “Where am I going?” 272, 282. A number of career choices 274 are provided with various job titles associated with certain career areas illustrated. Using these displays 270, 280, the student can begin to narrow his or her career destinations by considering his or her values, goals and by taking career assessments. Here again, the displays 270, 280 are each under the road sign for “Career Plan Pathway” which is located in “Career County” 271.

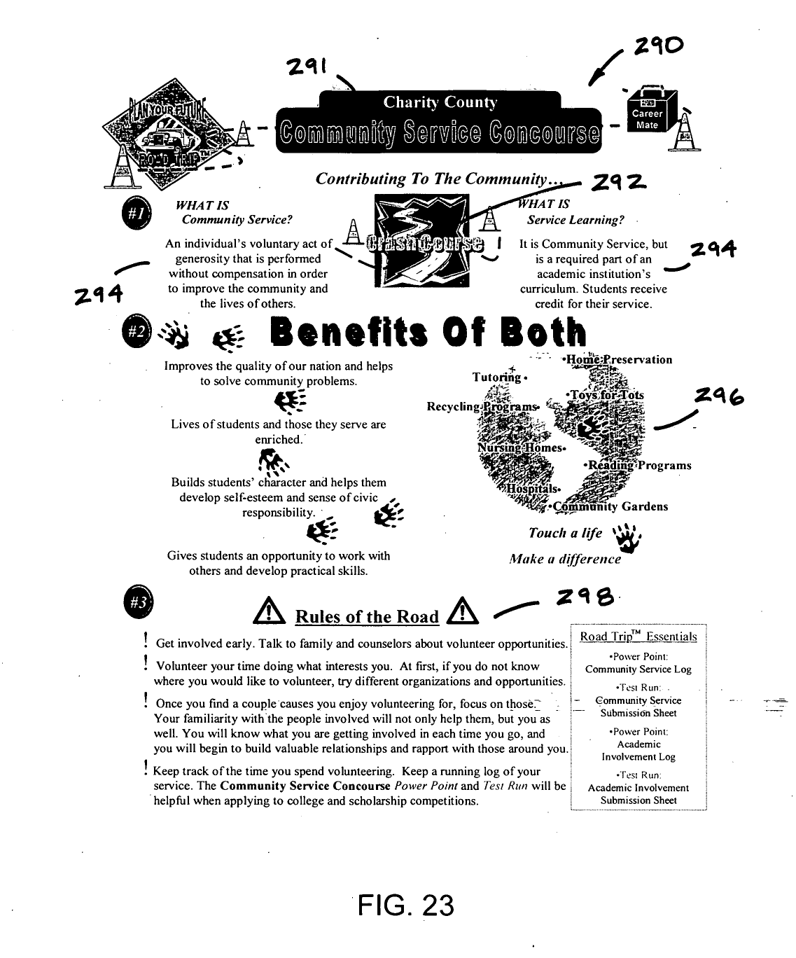

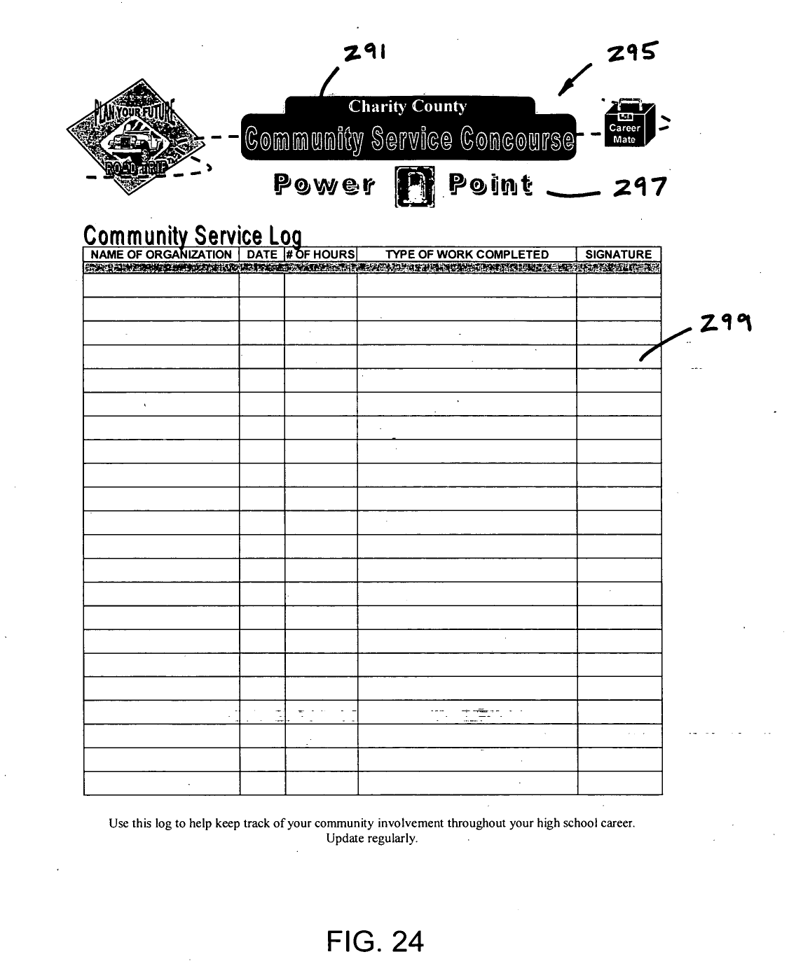

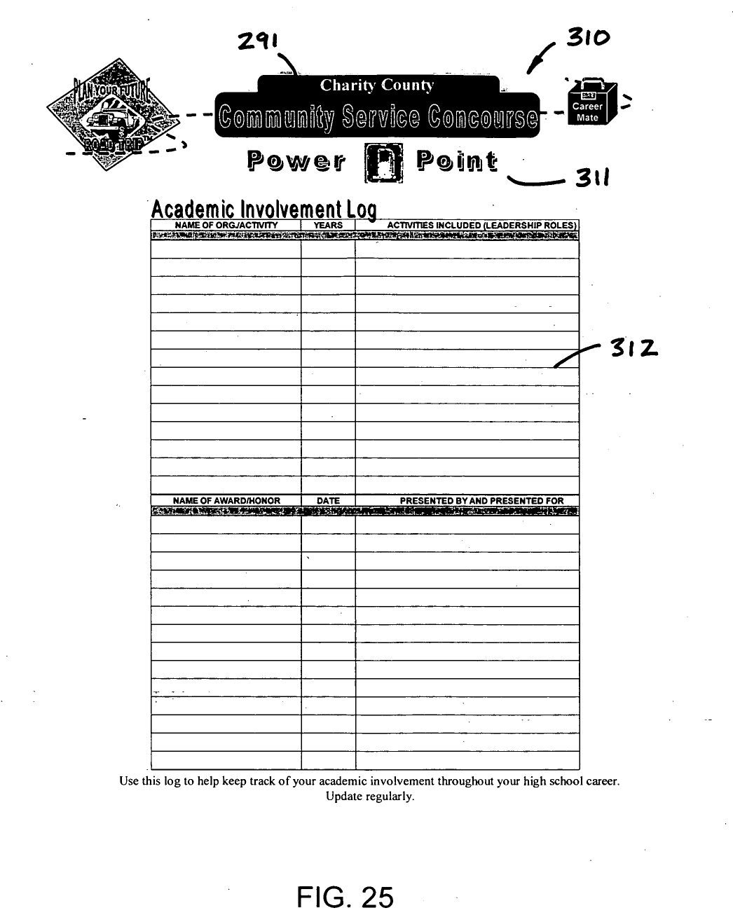

Referring now to FIGS. 23-25, additional displays 290, 295, 310 are provided, each of which is directed to activity, by road sign analogy, to “Community Service Concourse” which is located in “Charity County” 291. The first display 290 is another three-step “Crash Course” 292 for the purpose of having the student ask what he or she has contributed to his or her community 292. This display 290 provokes the user to ask what community service is and what service learning is 294. The display 290 also provides the user with a litany of topics 296 that identify the benefits of each of the topics of community service and service learning 296. As with other “Crash Course” components of the method and system of the present invention, this display 290 provides certain “Rules of the Road” 298 to be followed by the student as well. The related displays 295, 310 include a community service log 299 and an academic involvement log 312 wherein the student can enter certain relevant information involving his or her community service and academic achievement, respectively. This displays 295, 310 are also formatted as “Power Points” 297, 311 as previously described.

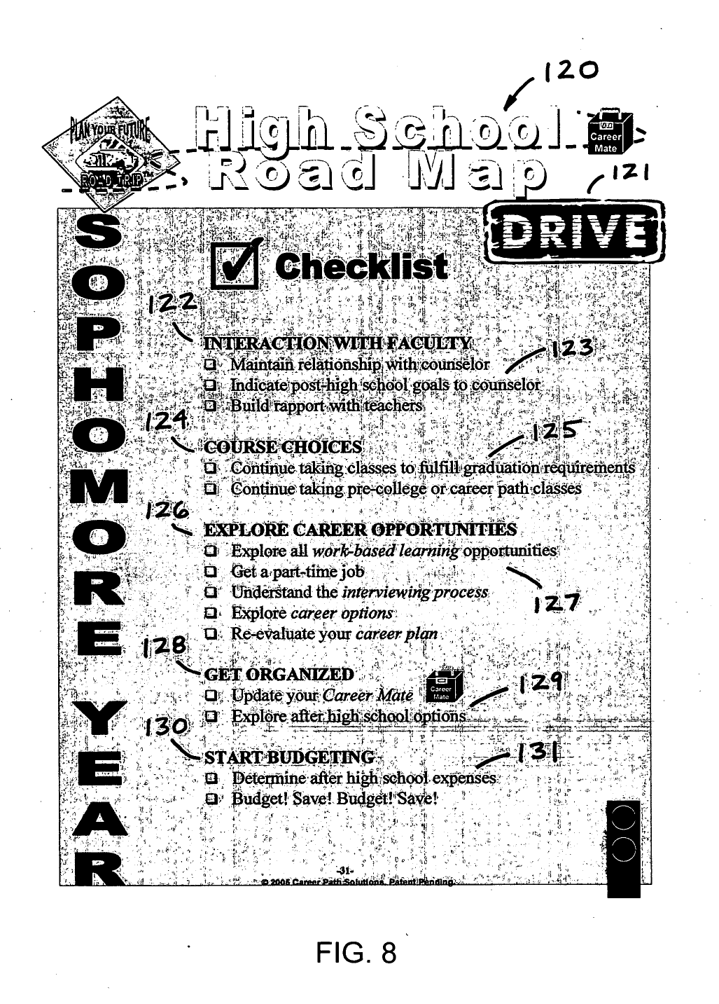

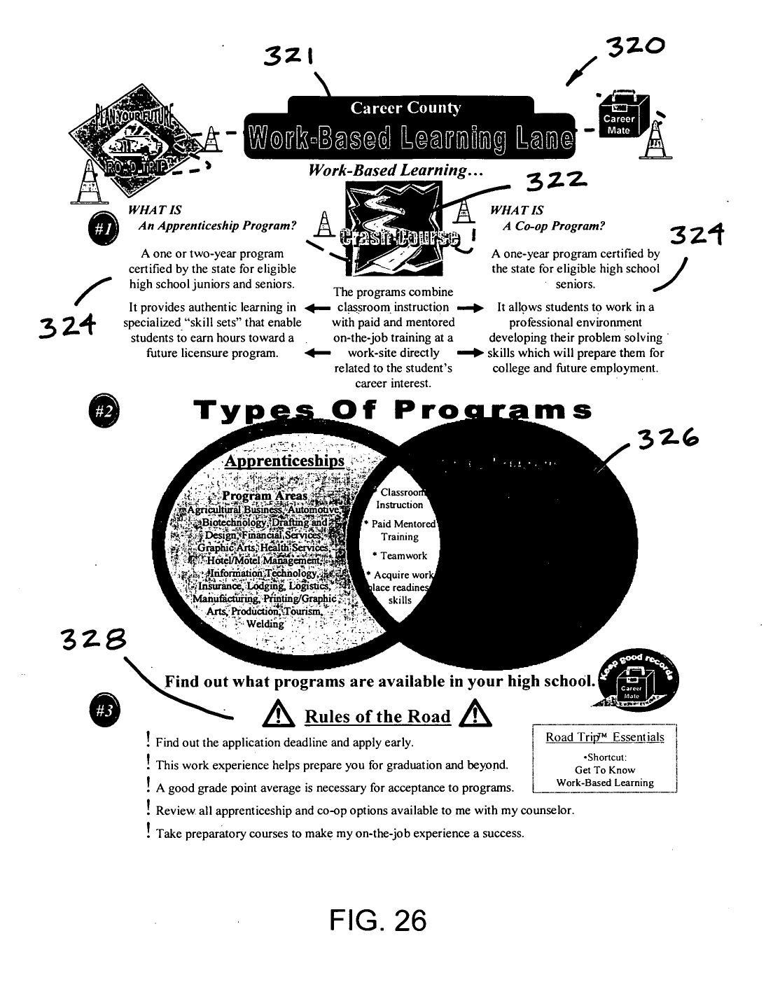

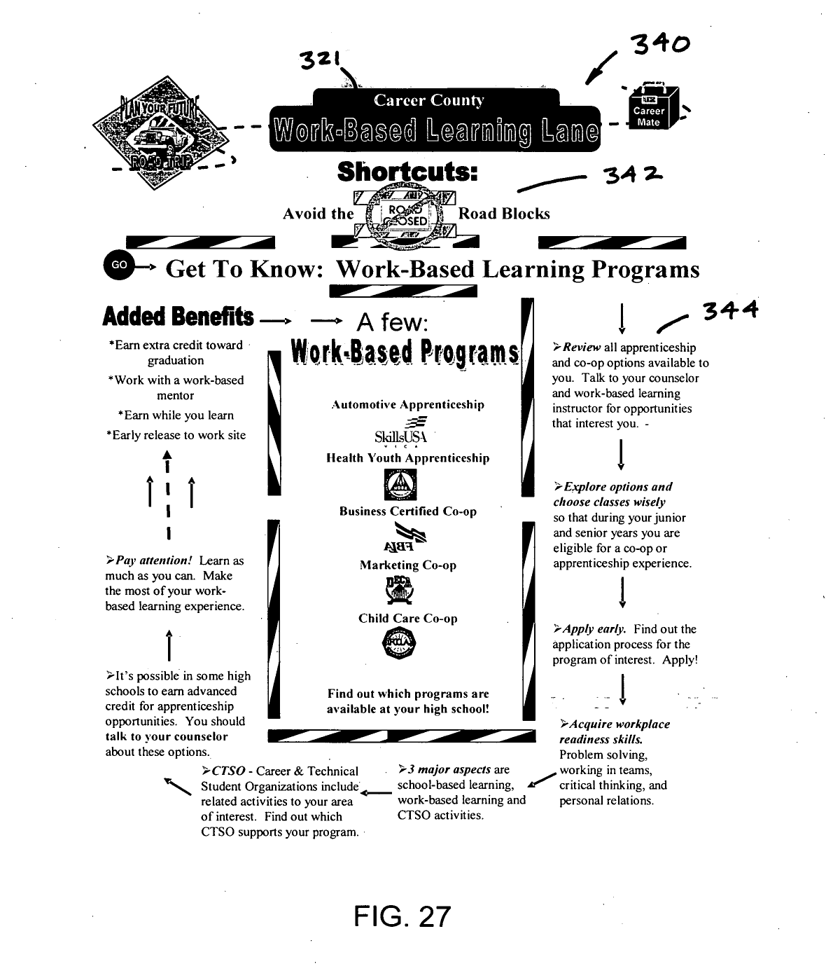

Referring now to FIGS. 26 and 27, each includes a display 320, 340 that is found on “Work-Based Learning Lane” located in “Career County” by road sign analogy 321. In the preferred embodiment, this display 320 would follow the display 120 shown in FIG. 8 as it relates to considerations that are to be made early on in the student's sophomore year. The first display 320 is another three-step “Crash Course” 322 that includes a first section 324 in which the student learns what an apprenticeship program is and what a co-op program is. This display 320 includes a second section 326 where the user explores both types of programs, including their similarities and differences by means of a Venn diagram. As with other “Crash Course” components of the method and system of the present invention, this display 320 similarly provides certain “Rules of the Road” 328 to be followed by the student as well. Similarly, FIG. 27 illustrates a two-dimensional display 340 with various suggested “Shortcuts” 342 for avoiding high school “Road Blocks” in this area. Among the specific suggestions 344 provided are “Explore options and choose classes wisely” and “Apply early”, among others. Each suggestion 344 is intended to be a reminder and a thought-provoking tip for the user.

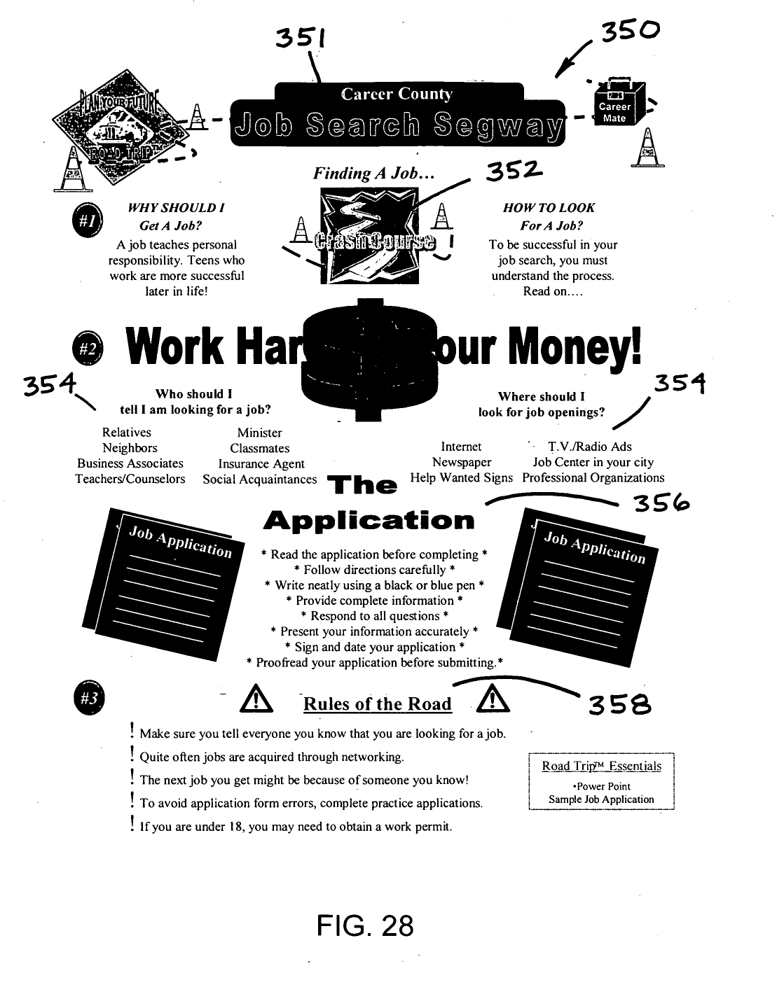

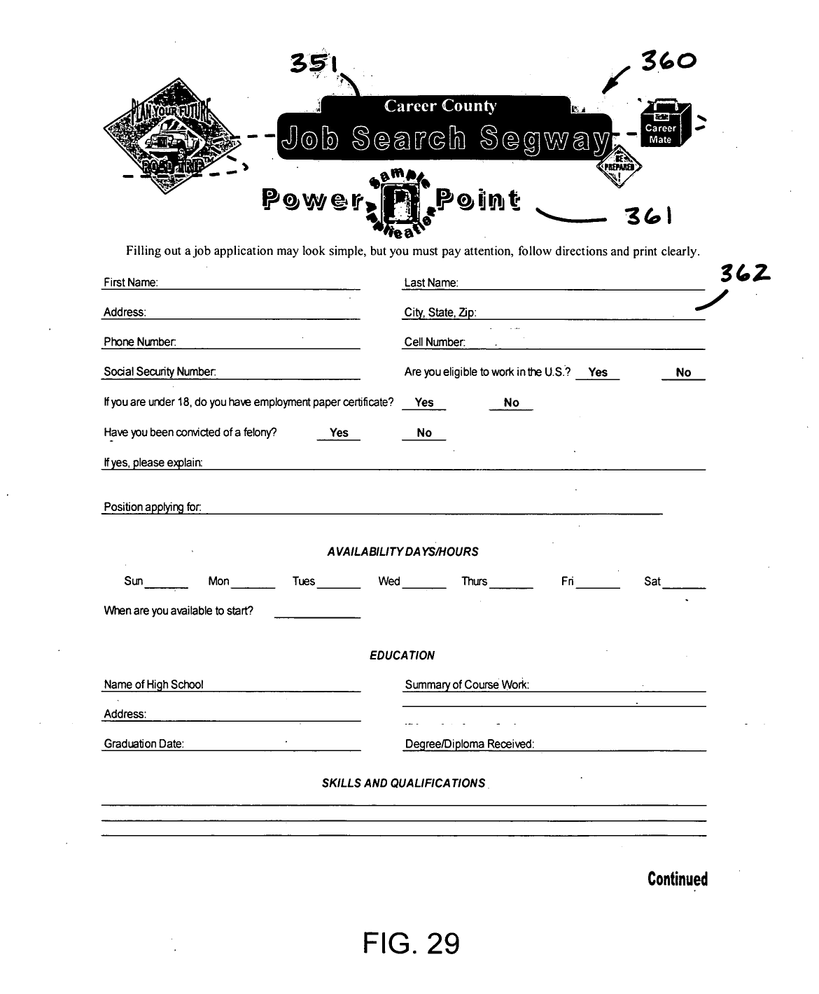

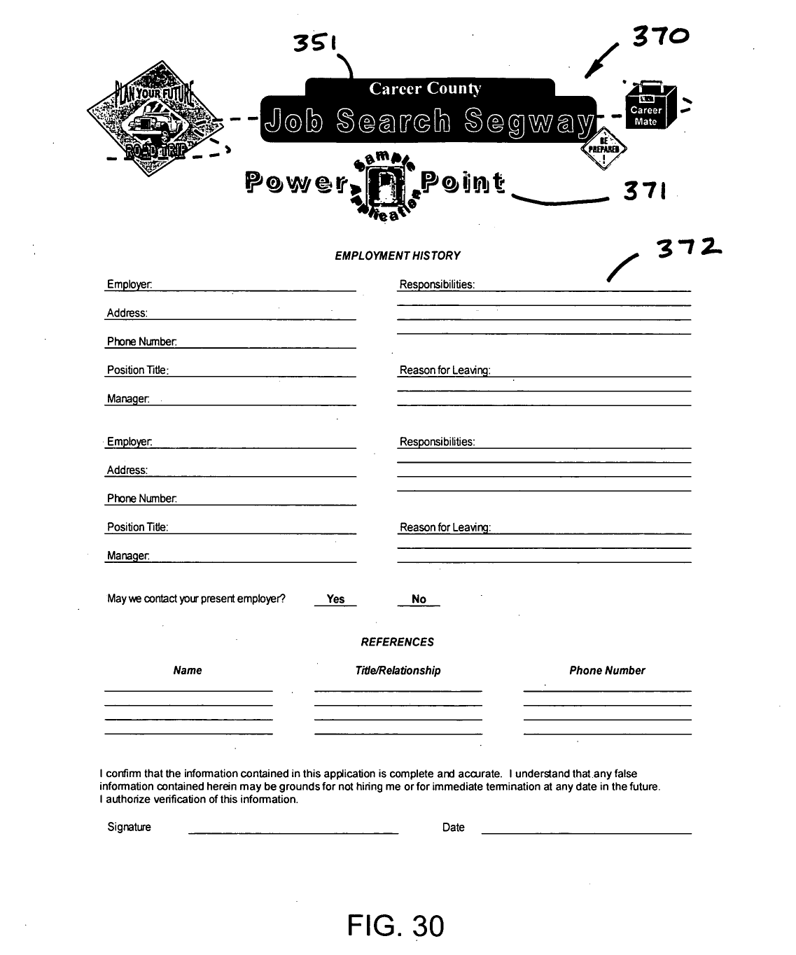

Referring now to FIGS. 28-30, additional displays 350, 360, 370 are provided, each of which is directed to activity, by road sign analogy, to “Job Search Segway” which is located in “Career County” 351. The first display 350 is yet another three-step “Crash Course” 352 for the purpose of having the student ask why he or she should get a job and, if so, how to successfully look for a job. This display 350 motivates the user to question who he or she should tell about his or her job search and where to look for job openings 354. The display 350 also provides the user with a ground rules for completing a job application 356. As with the other “Crash Course” components of the method and system of the present invention, this display 350 also provides certain “Rules of the Road” 358 to be followed by the student as well. The related displays 360, 370 include an exemplary list 362, 372 of basic information that the user may encounter on a typical job application. The lists 362, 372 prepare the user to accumulate certain relevant information including availability, employment history, and skills and qualifications that the user may possess for any job that the user may apply for. This displays 360, 370 are also formatted as a “Power Points” 361, 371 that remind the user to filed all completed “Power Points” in his or her “Career Mate” 300 for safe-keeping and future reference.

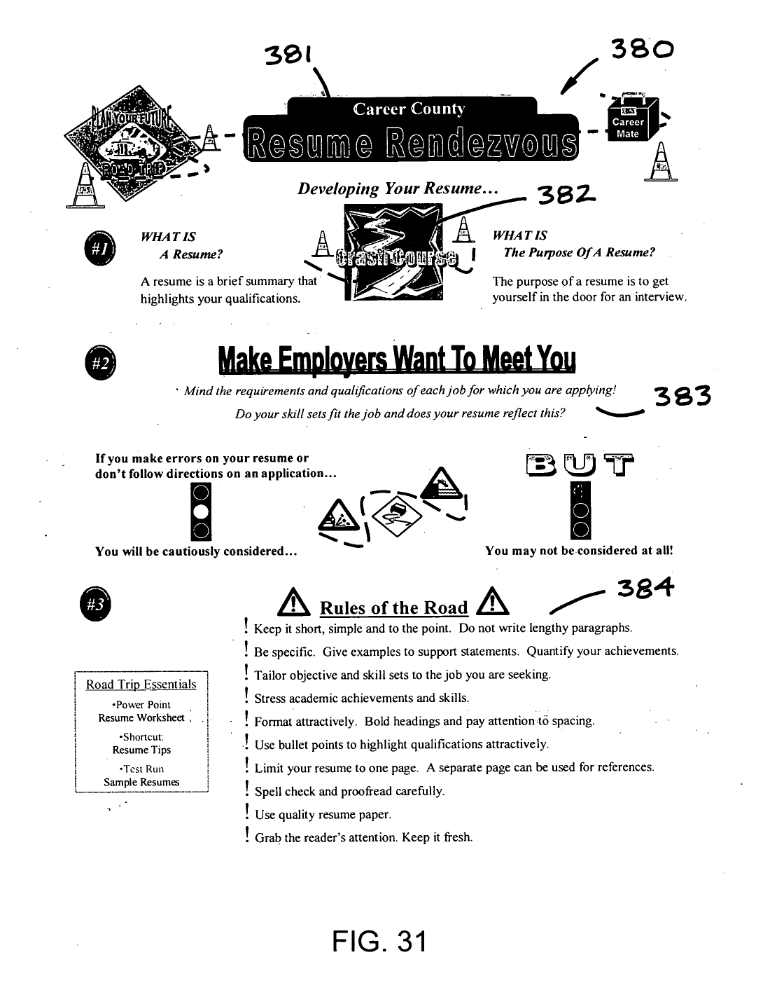

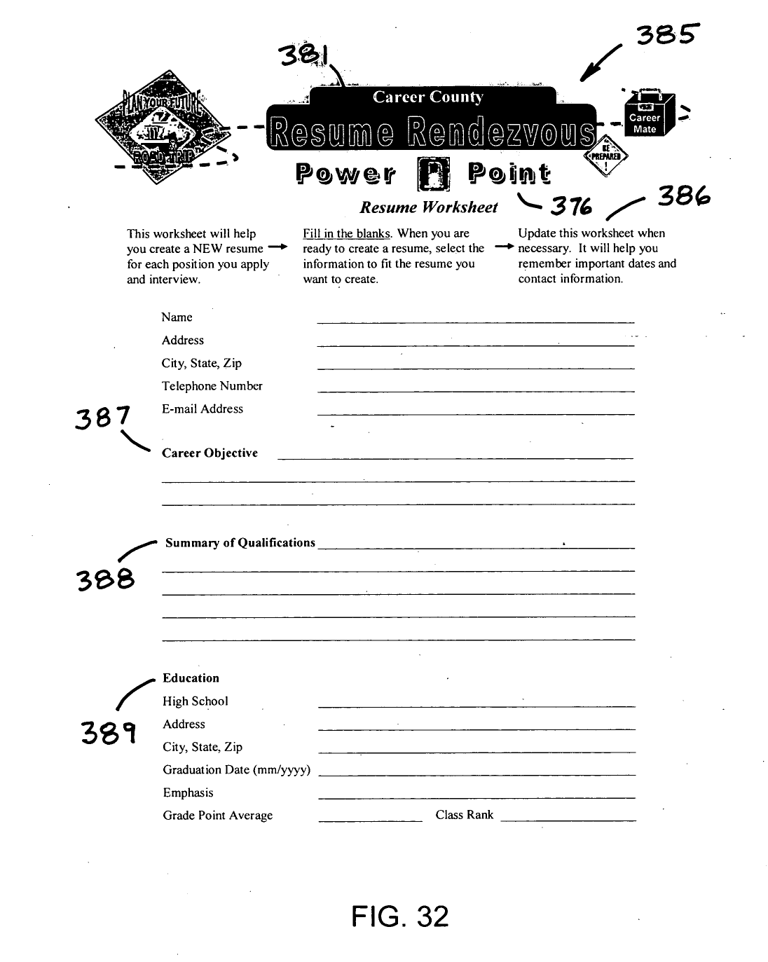

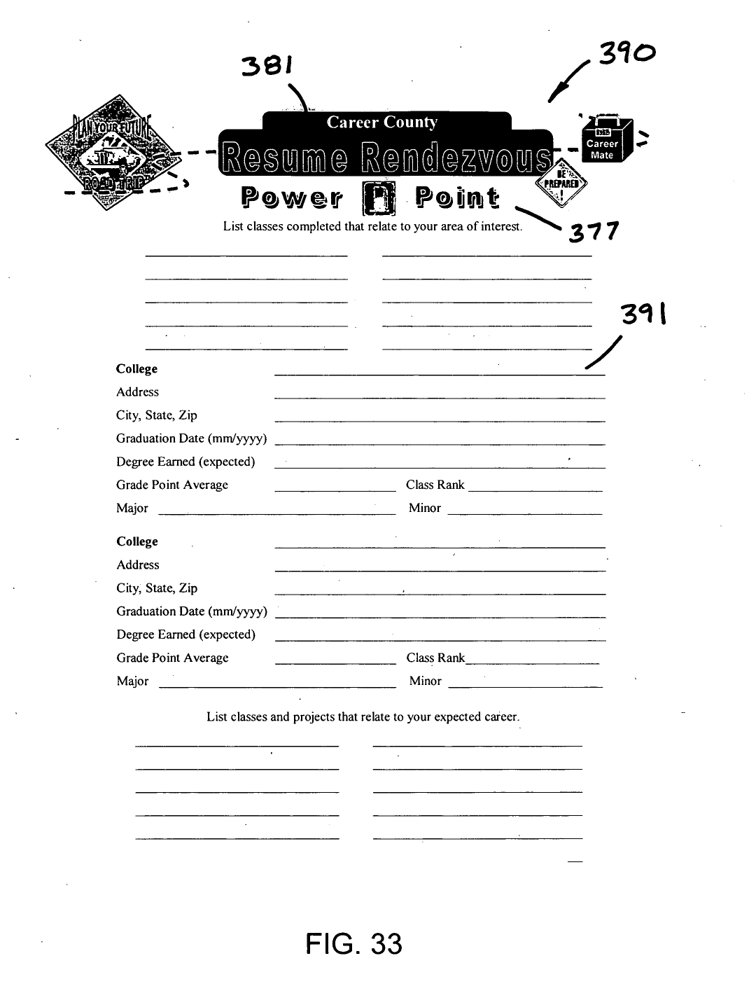

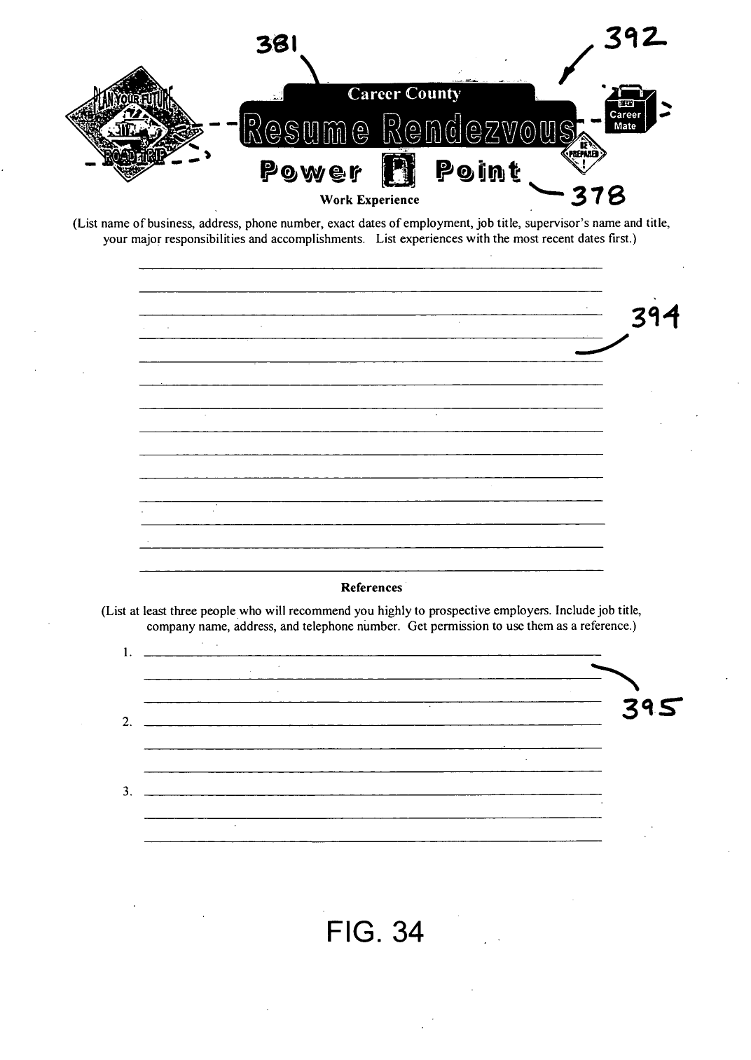

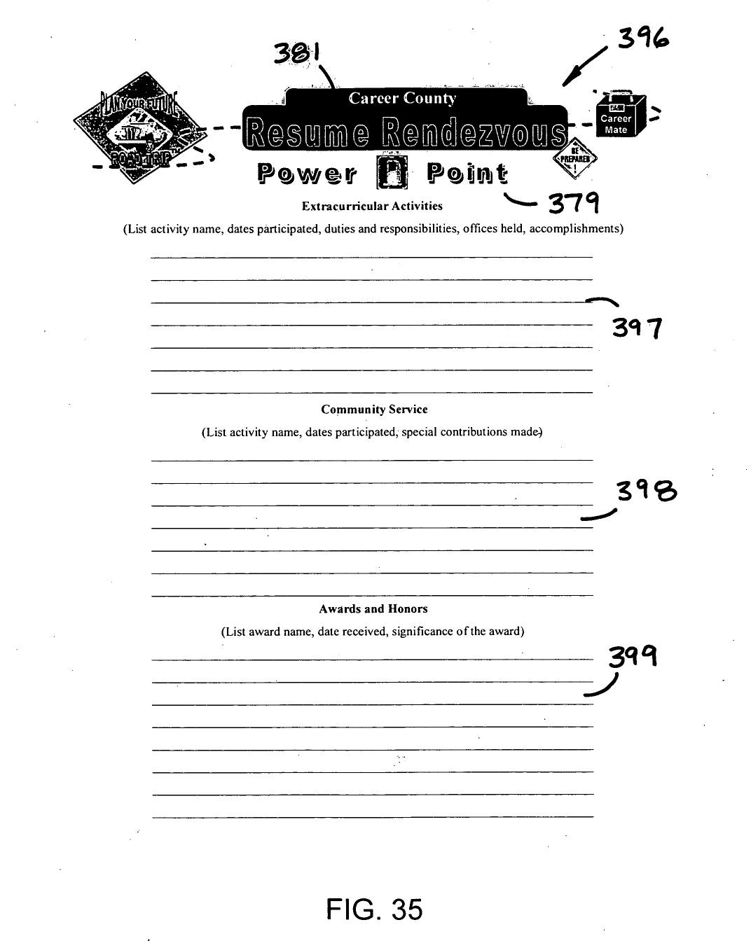

As shown in FIGS. 31-35, additional displays 380, 385, 390, 392, 396 are provided, displays 385, 390, 392, 396 being in “Power Point” format 376, 377, 378, 379, respectively. These displays 380, 385, 390, 392, 396 are directed to activity, by still another road sign analogy, to “Resume Rendezvous” which is also located in “Career County” 381. The first display 380 is a three-step “Crash Course” 382 for the purpose of guiding the student through the process of developing his or her resume. This display 380 helps the user create a resume that will get the user in the employer's door for a job interview. The display 380 also provides the user with an opportunity to consider factors that an employer would consider when evaluating the student for a position 383. As with the other “Crash Course” components of the method and system of the present invention, this display 380 also provides certain “Rules of the Road” 384 to be followed by the student as well. The related displays 385, 390, 392, 396 each contain a portion of a “Resume Worksheet” 386 that force the user to consider his or her career objective 387, a summary of his or her qualifications 388, details of his or her high school and college education 389, 391, his or her work experience 394, references 395, extracurricular activities 397, community service 398, and awards and honors 399.

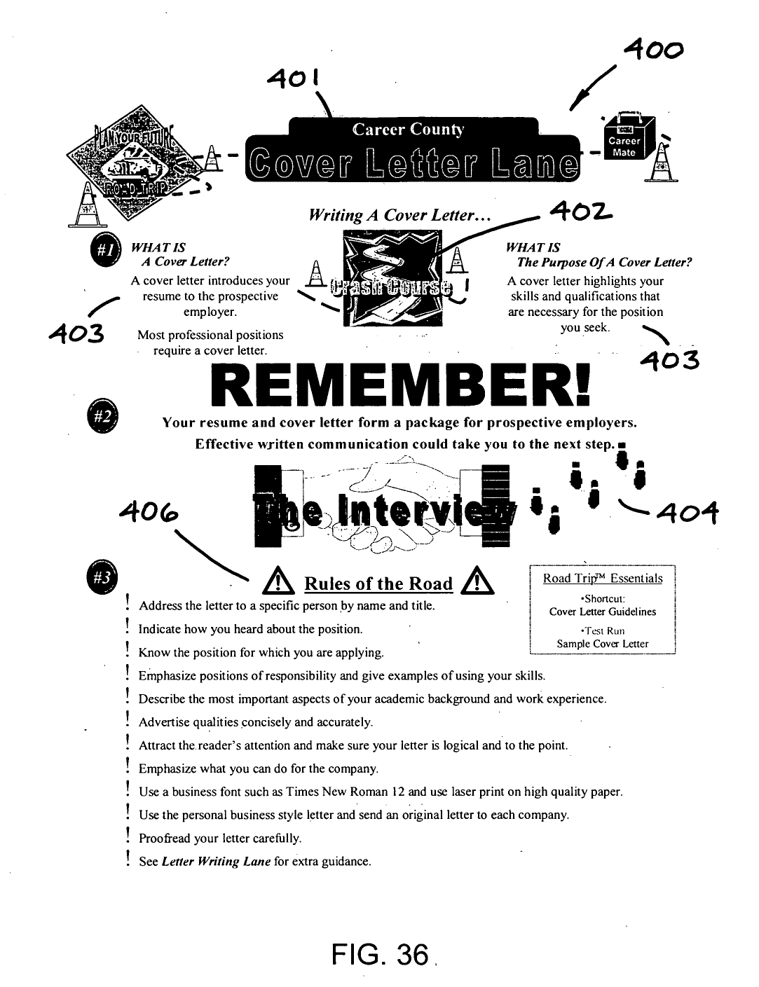

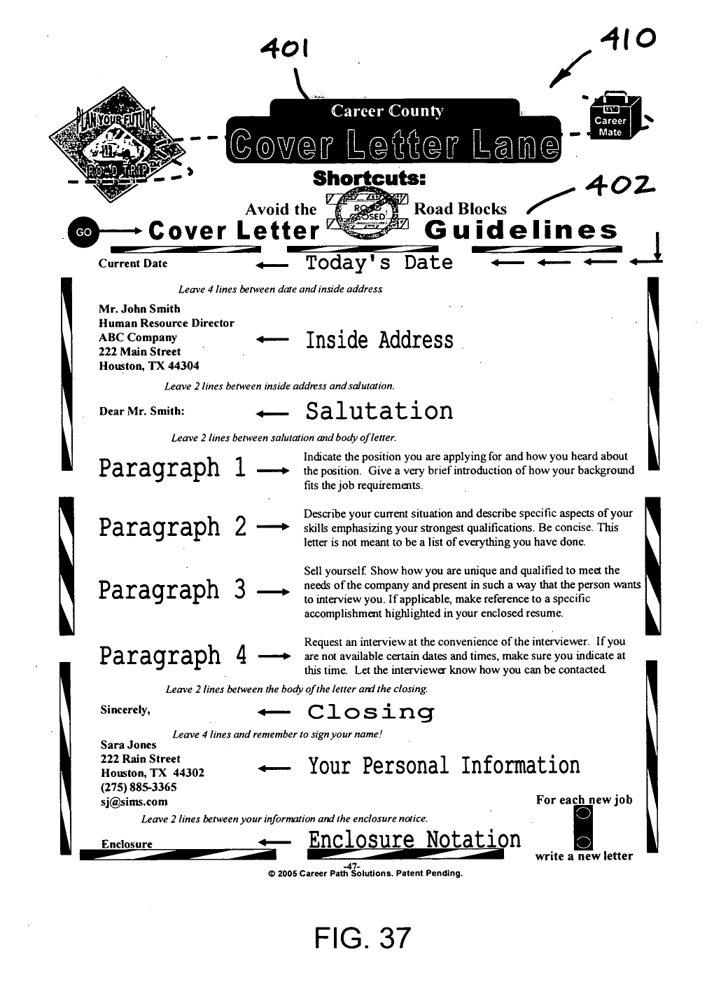

Referring now to FIGS. 36 and 37, each includes a display 400, 410 that is found on “Cover Letter Lane” which is also located in “Career County” by road sign analogy 401. The first display 400 is another three-step “Crash Course” 402 that includes a first section 403 in which the student learns what a cover letter is and what purpose it serves. This display 400 includes a second section 404 that reminds the user that the resume and cover letter form a “package” for prospective employers. As with other “Crash Course” components of the method and system of the present invention, this display 400 also provides a “Rules of the Road” section 406 which gives the student certain cover letter guidelines. The related display 410 includes shortcuts 412 for avoiding certain “road blocks” to writing a good cover letter. See FIG. 37. The method and system of the present invention may also include one or more sample cover letters (not shown) for use by the student.

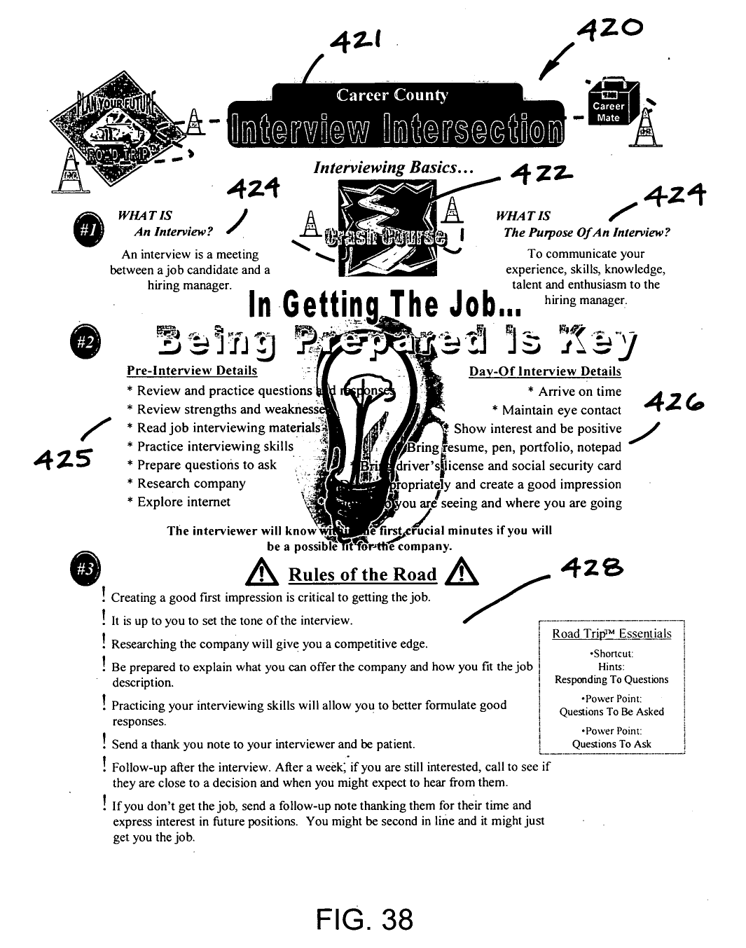

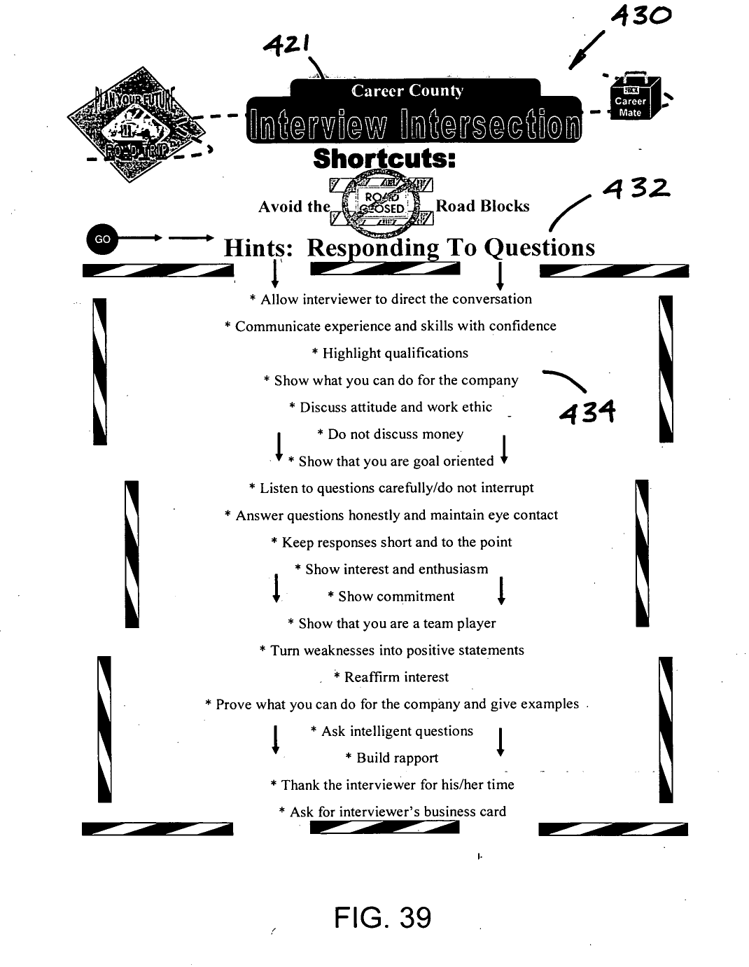

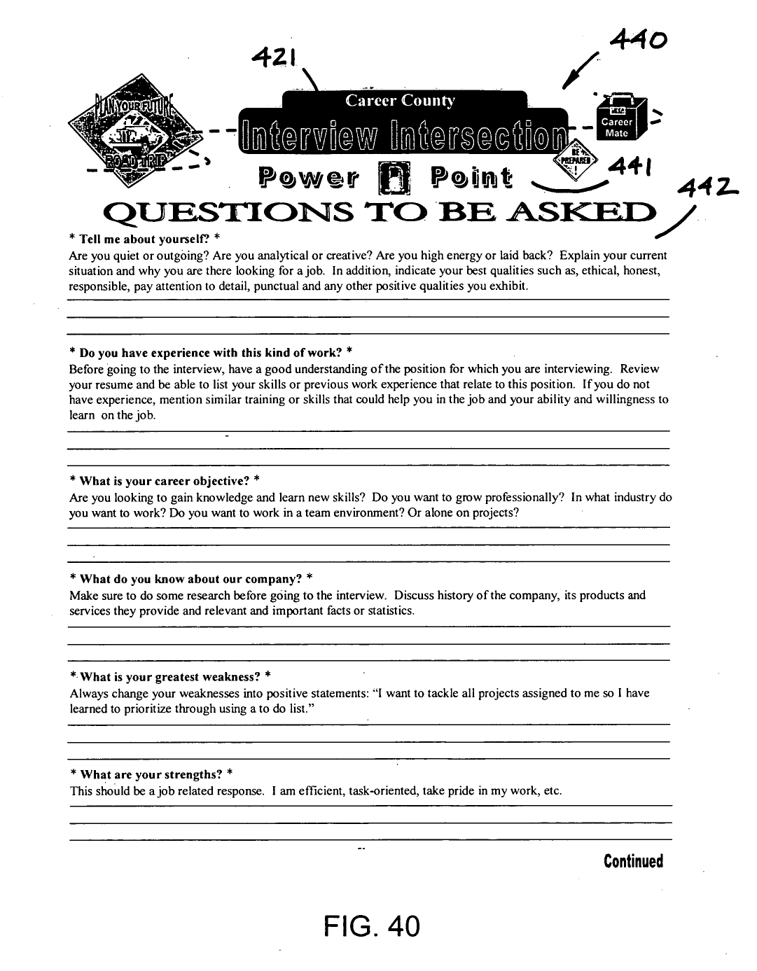

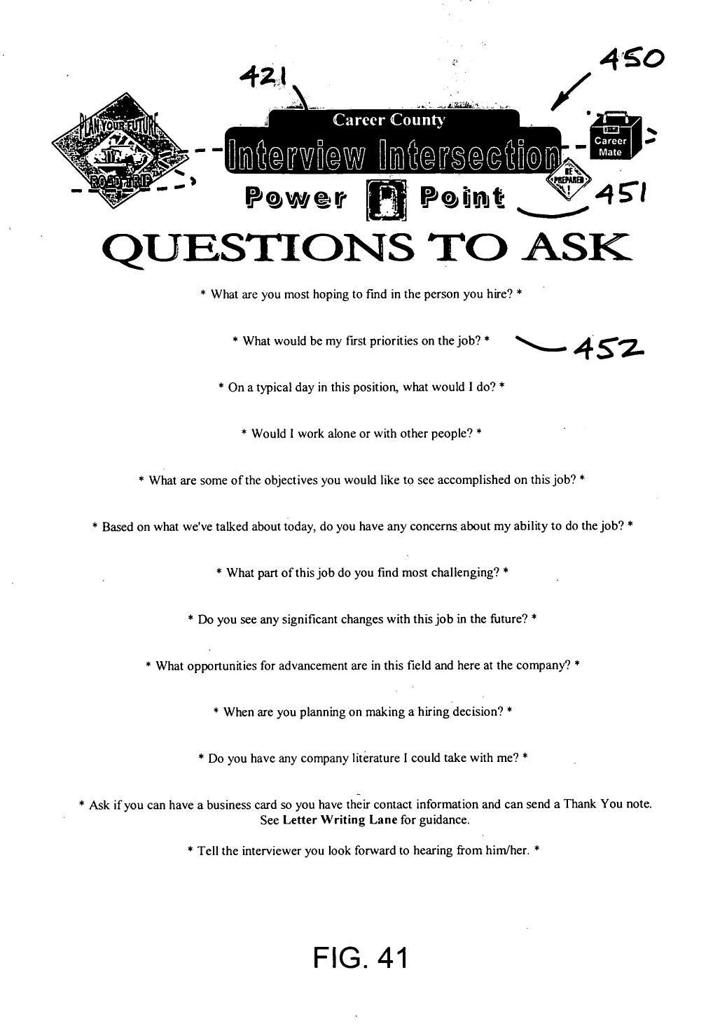

As shown in FIGS. 38-41, additional displays 420, 430, 440, 450 are provided. These displays 420, 430, 440, 450 are directed to activity, by still another road sign analogy, to “Interview Intersection” which is also located in “Career County” 421. The first display 420 is a three-step “Crash Course” 422 for preparing the student for the interview process. This display 420 includes a section 424 that helps the user understand what an interview is and what purpose it serves. The display 420 also provides the user with an opportunity to review “pre-interview” details 425 and “day-of interview” details 426. As with the other “Crash Course” components of the method and system of the present invention, this display 420 also provides certain “Rules of the Road” 428 to be followed by the student for preparing for an interview and conducting post-interview follow-up. The related display 430 shown in FIG. 39 includes a “Shortcut” 432 which contains certain hints and suggestions 434 for responding to interview questions. The other related displays 440, 450 include a litany of pointed “Questions to be asked” 442 and “Questions to ask” 452. Each is presented in a worksheet “Power Point” 441, 451 format as well. See FIGS. 40 and 41.

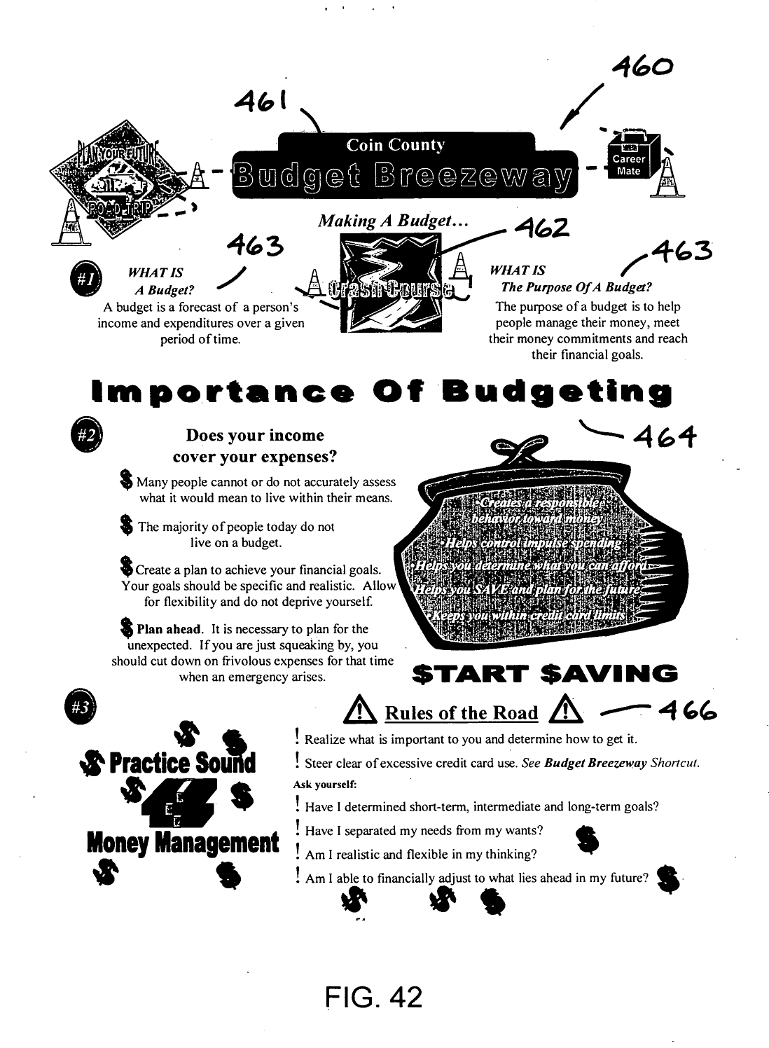

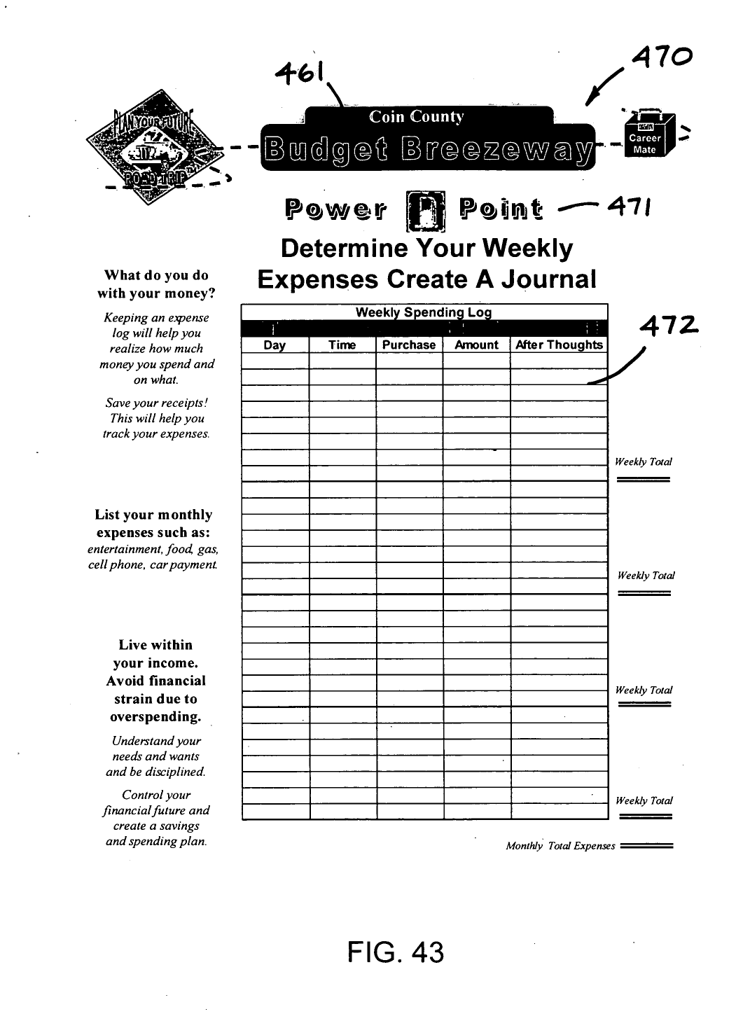

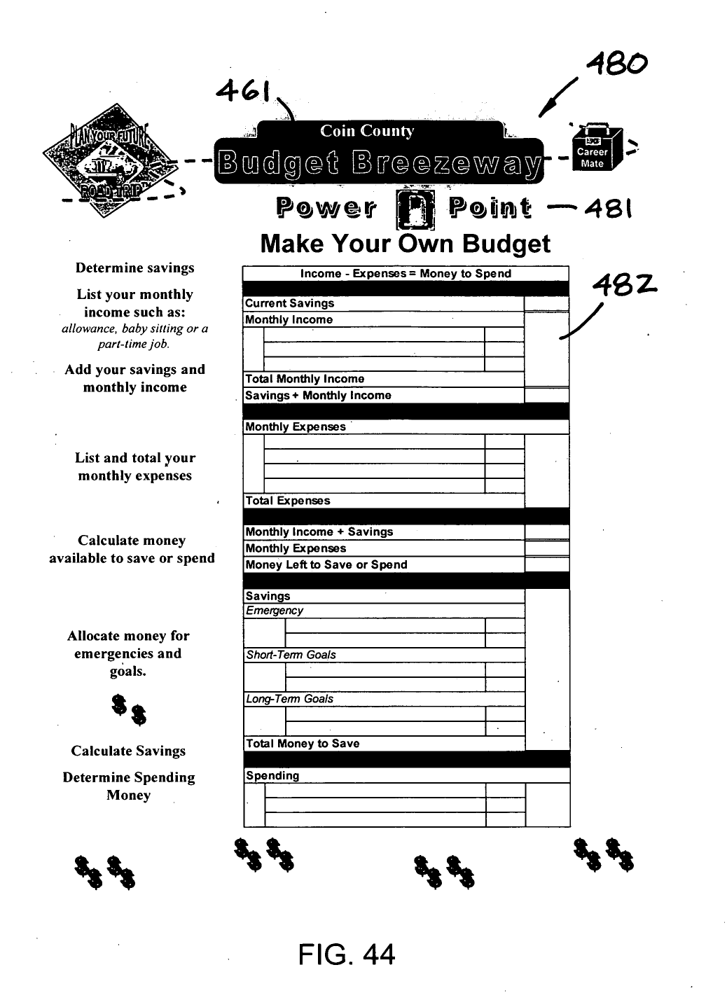

Referring now to FIGS. 42-44, each includes a display 460, 470, 480 that is found on a new imaginary street named “Budget Breezeway” which is located in “Coin County” by road sign analogy 461. The first display 460 is yet another three-step “Crash Course” 462 that includes a first section 463 in which the student learns what a budget is as well as what purpose it serves. This display 460 includes a second section 464 that reminds the user of the importance of budgeting. As with other “Crash Course” components of the method and system of the present invention, this display 460 also provides a “Rules of the Road” section 466 which gives the student certain guidelines that are directed to saving and spending money. The first related display 470 includes a weekly spending log 472 that the student can use to list his or her monthly expenses. The second related display 480 includes a budget worksheet 482 that the student can use to make his or her budget. The displays 470, 480 are also formatted “Power Points” 471, 481 in that each reminds the user to file all completed “Power Points” in his or her “Career Mate” 300 for safe-keeping and future reference.

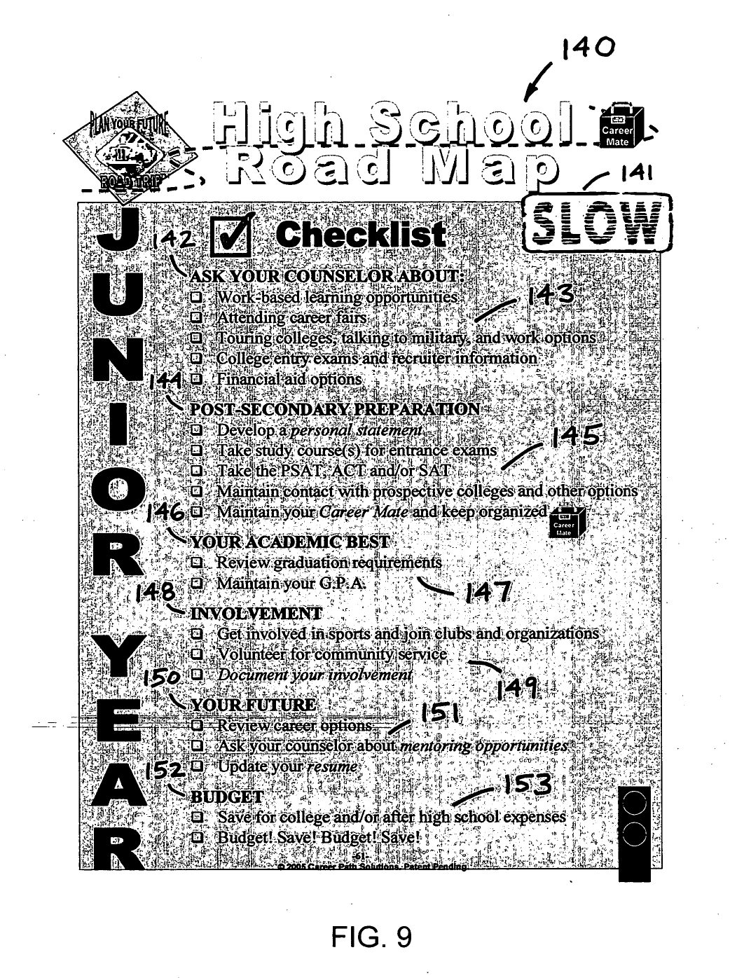

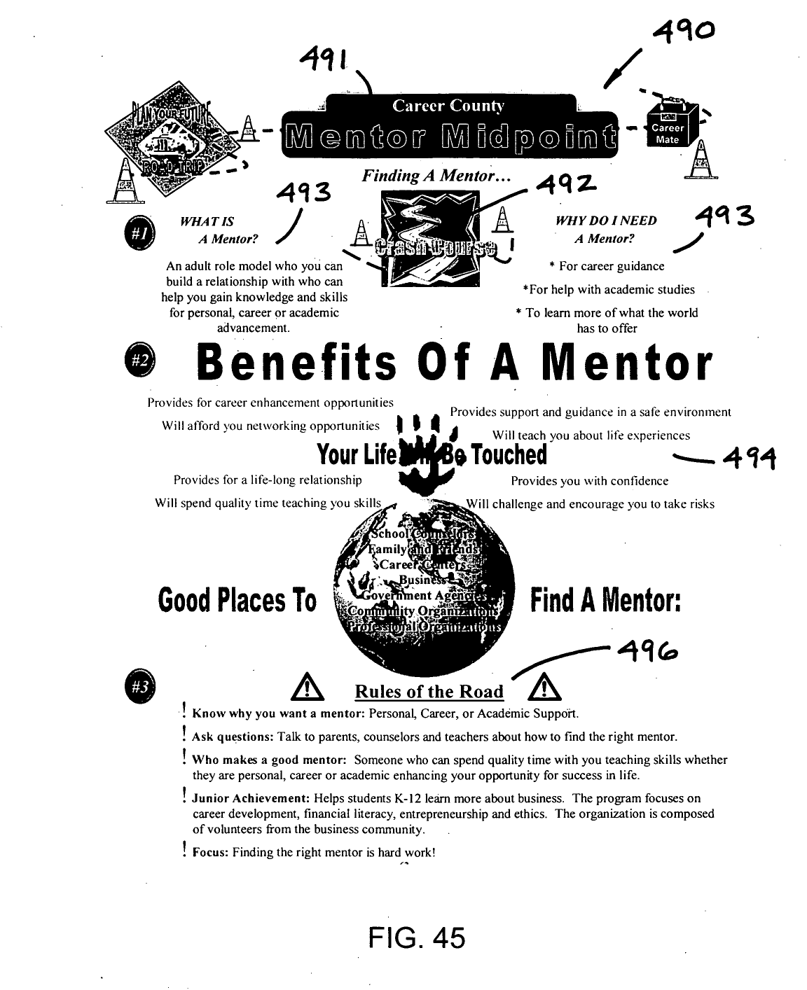

FIG. 45 includes a display 490 that directs the user to “Mentor Midpoint” which is located in “Career County” 491. In the preferred embodiment, this display 490 would follow the display 140 shown in FIG. 9 as it relates to the student's junior year, as do the displays that follow it. This display 490 is a “Crash Course” 492 on the benefits of finding a mentor. It asks and answers the questions, “What is a mentor?” and “Why do I need a mentor?” 493. The display 490 identifies 494 the benefits of having a mentor and includes “Rules of the Road” 496 to be considered by the student and user.

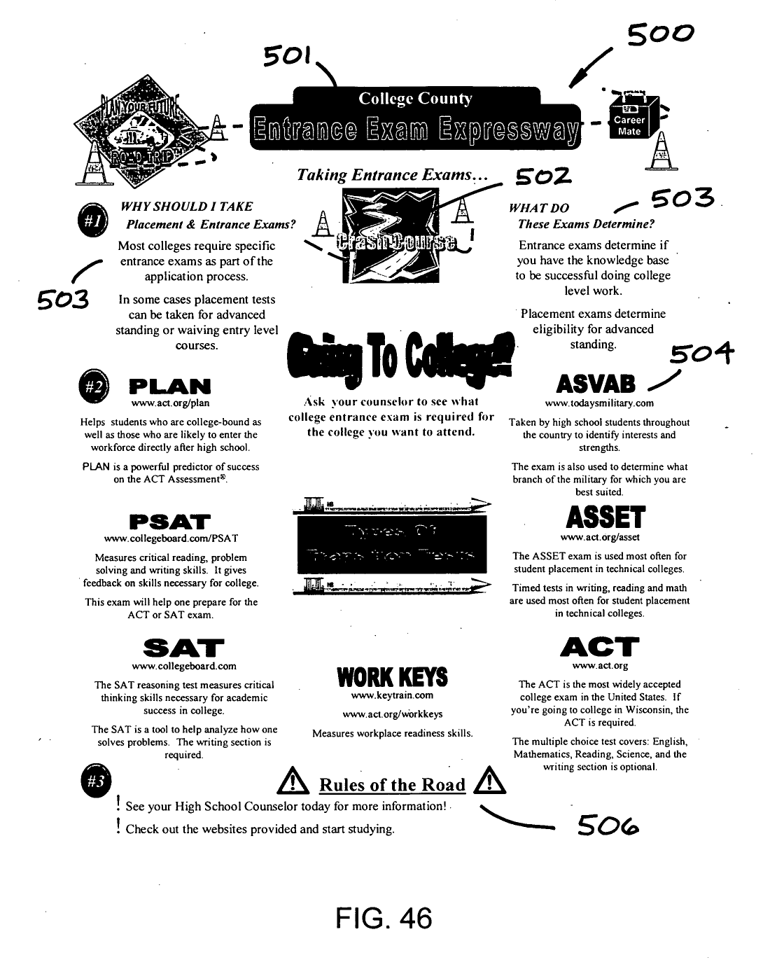

FIG. 46 includes a display 500 that directs the user to “Entrance Exam Expressway” which is located in “College County” 501. This display 500 is another “Crash Course” 502 on the subject of taking college entrance exams. It asks and answers the questions, “Why should I take placement and entrance exams?” and “What do these exams determine?” 503. The display 500 identifies 504 various types of transition tests and includes “Rules of the Road” 506 to be considered by the user.

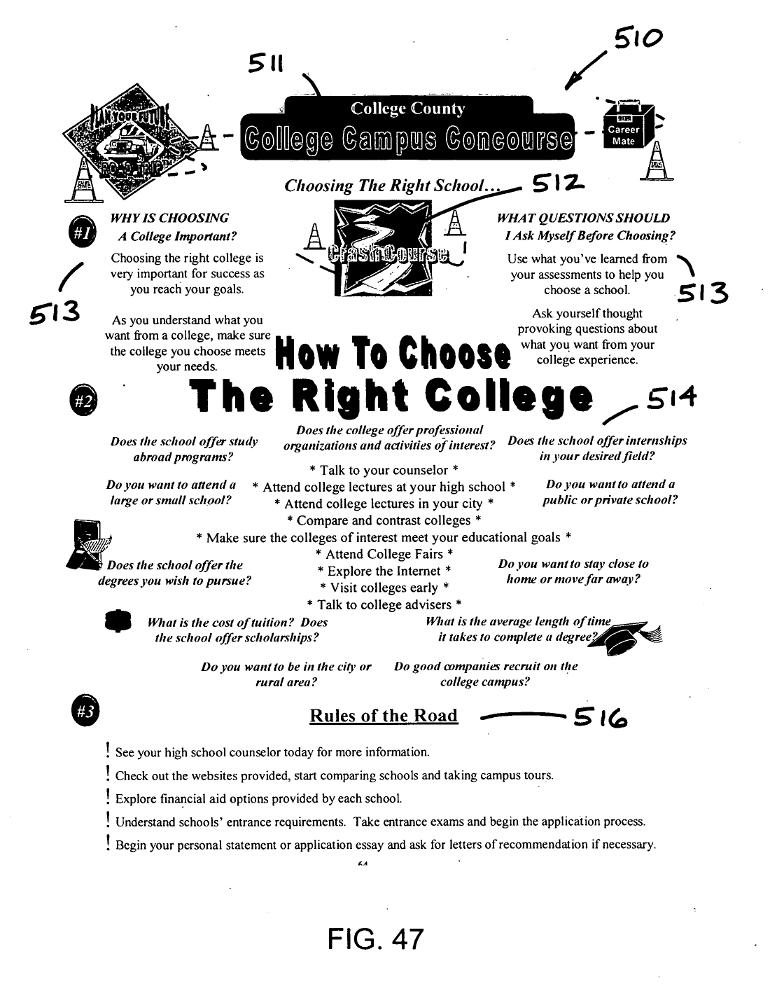

FIG. 47 includes another display 510 that directs the user to “College Campus Concourse” which is also located in “College County” 511. This display 510 comprises a “Crash Course” 512 on choosing the right school. It asks and answers the questions, “Why is choosing a college important?” and asks the student to ask other probing questions about the college selection process 513. The display 510 identifies guidelines 514 for choosing the right college and includes “Rules of the Road” 516 to be considered by the student.

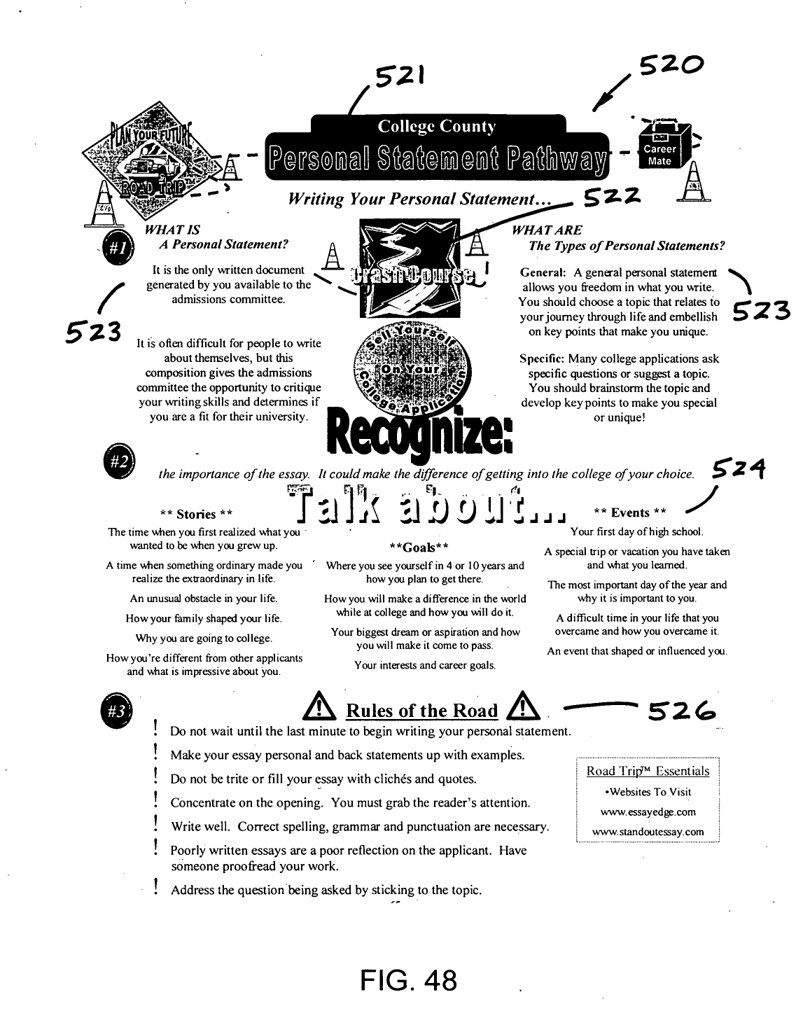

FIG. 48 includes a display 520 that instructs the user as to how to prepare a personal statement at “Personal Statement Pathway” which is located in “College County” 521. This display 520 is a “Crash Course” 522 on items to be considered in preparing a personal statement. It asks and answers the questions, “What is a personal statement?” and “What are the types of personal statements?” 523. The display 520 identifies 524 the elements of a well-composed personal statement and includes “Rules of the Road” 526 to be considered by the student and user.

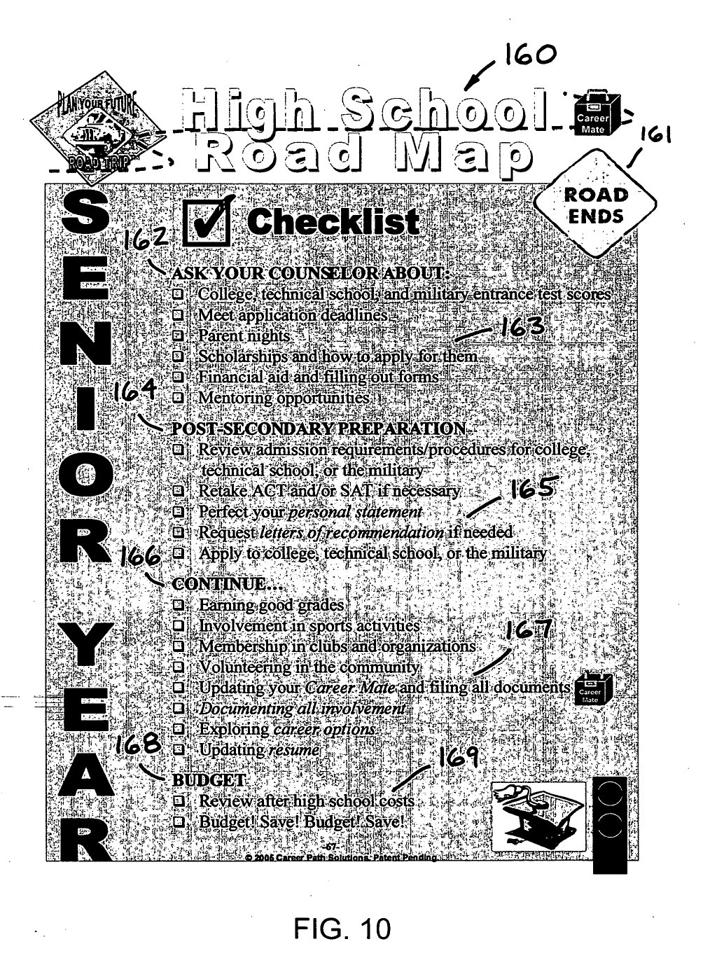

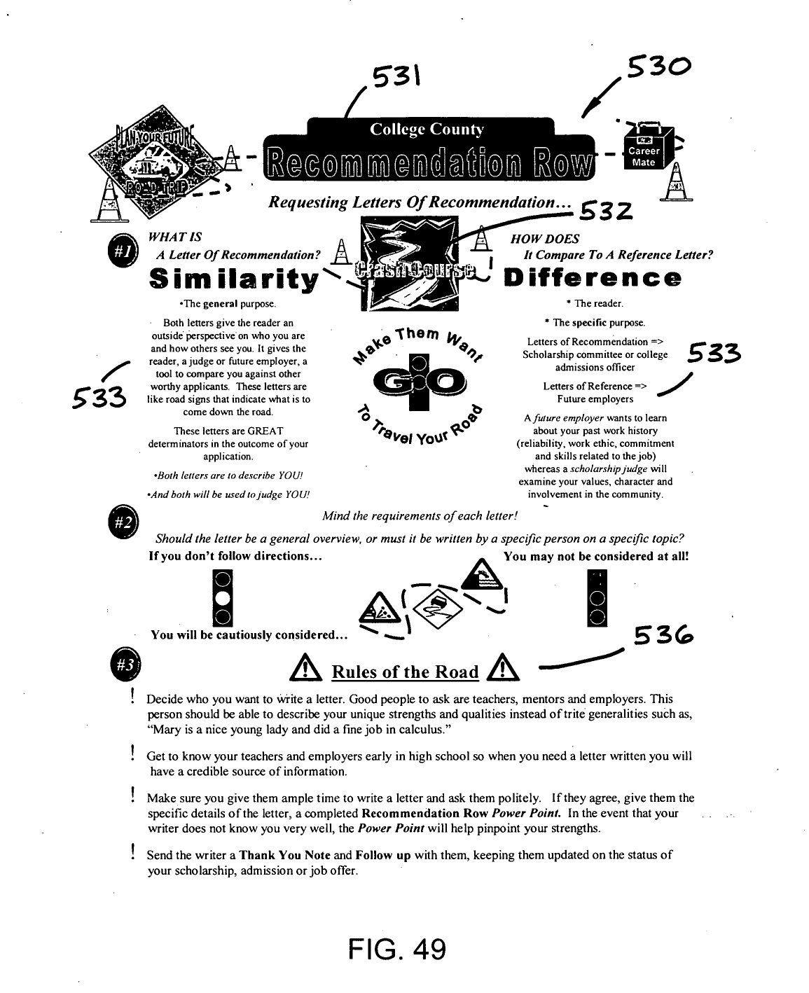

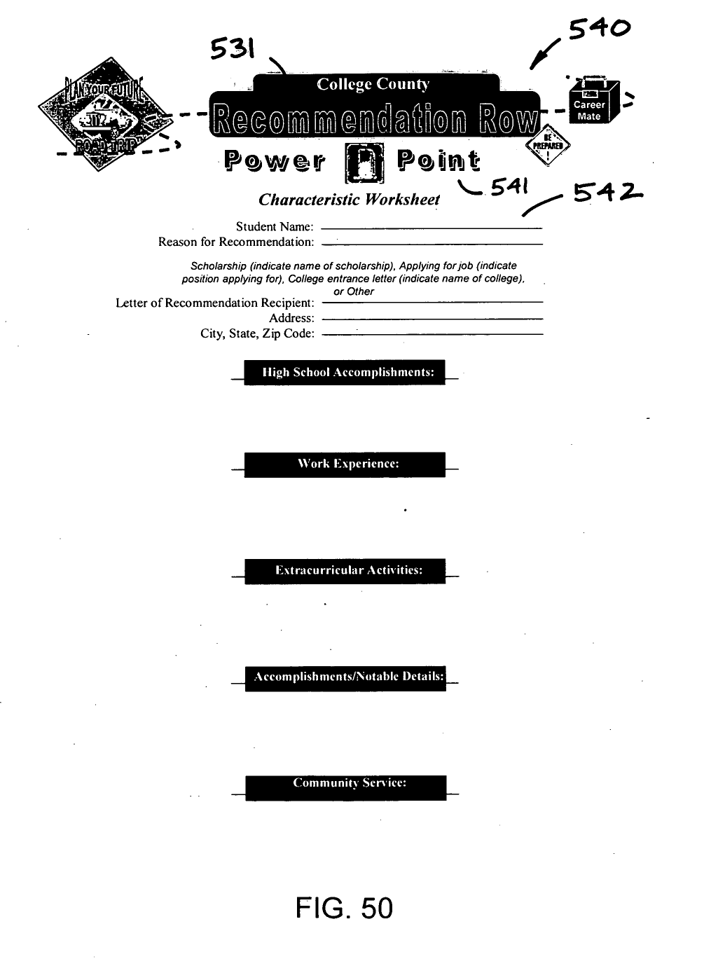

Referring now to FIGS. 49 and 50, each includes a display 530, 540 that is found on “Recommendation Row” which is also located in “College” by its road sign analogy 531. In the preferred embodiment, this display 530 would follow the display 160 shown in FIG. 10 as it relates to considerations that are to be made early in the student's senior year of high school. The first display 530 is another three-step “Crash Course” 532 that includes a first section 533 in which the student learns what a letter of recommendation is. It also includes a “Rules of the Road” section 536 which gives the student certain guidelines for considering who should assist the student with any letters of recommendation, how to approach them and how to thank them properly. The related display 540 is formatted as a “Power Point” 541 and includes a characteristics worksheet 542 which assists the student in providing the giver of a letter of recommendation some relevant information regarding the student and his or her request for a letter of recommendation.

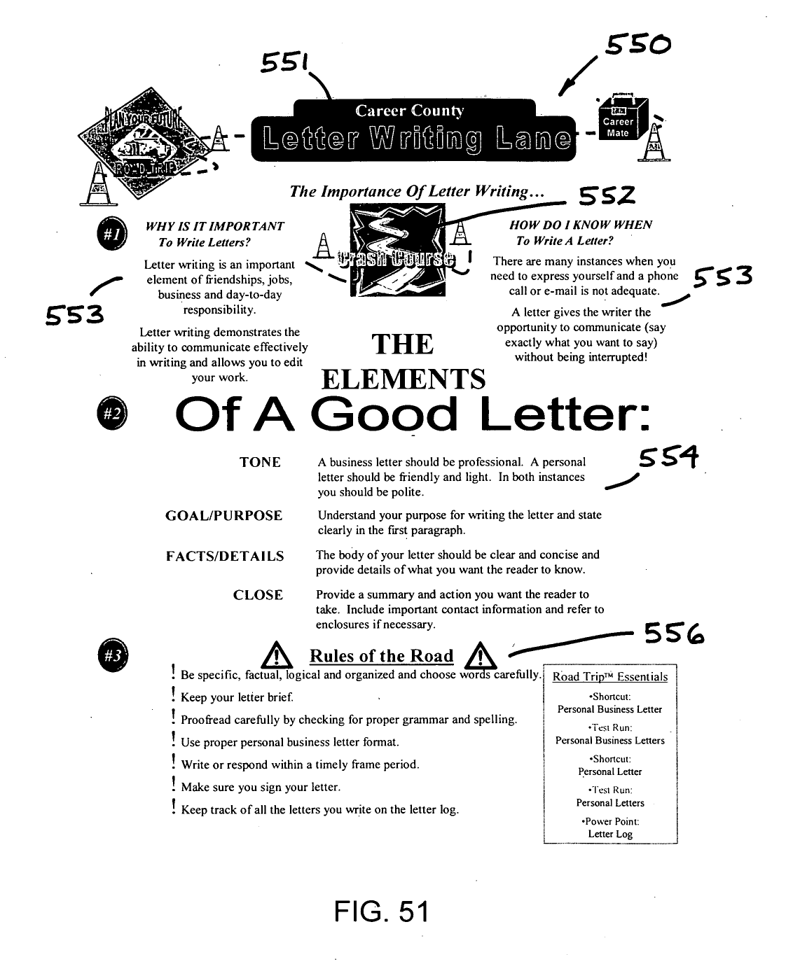

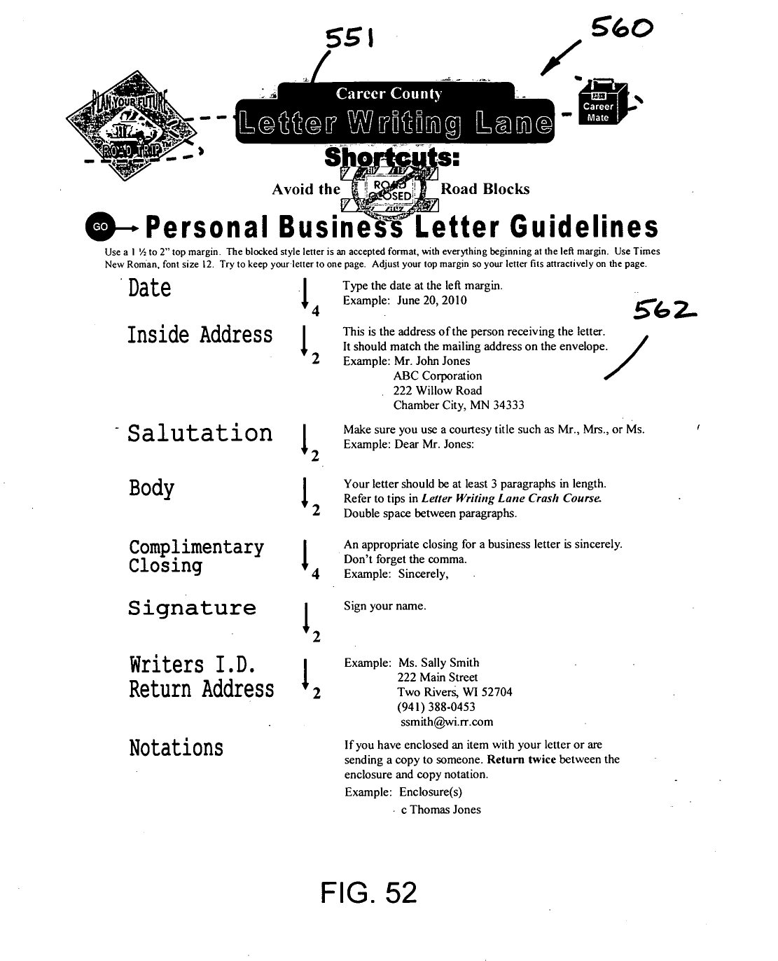

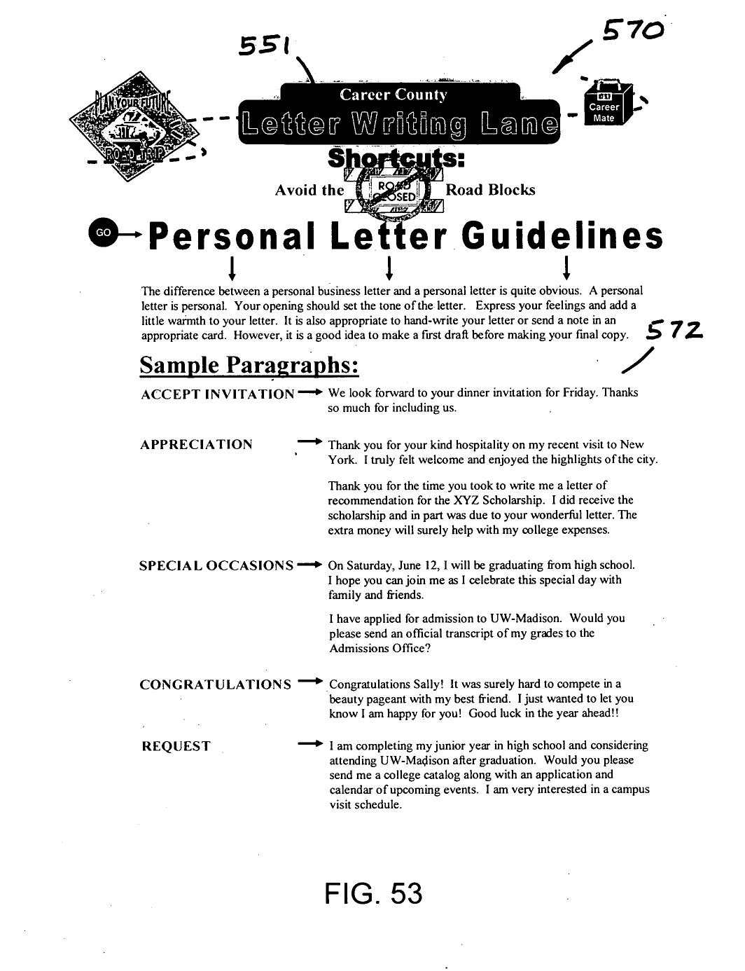

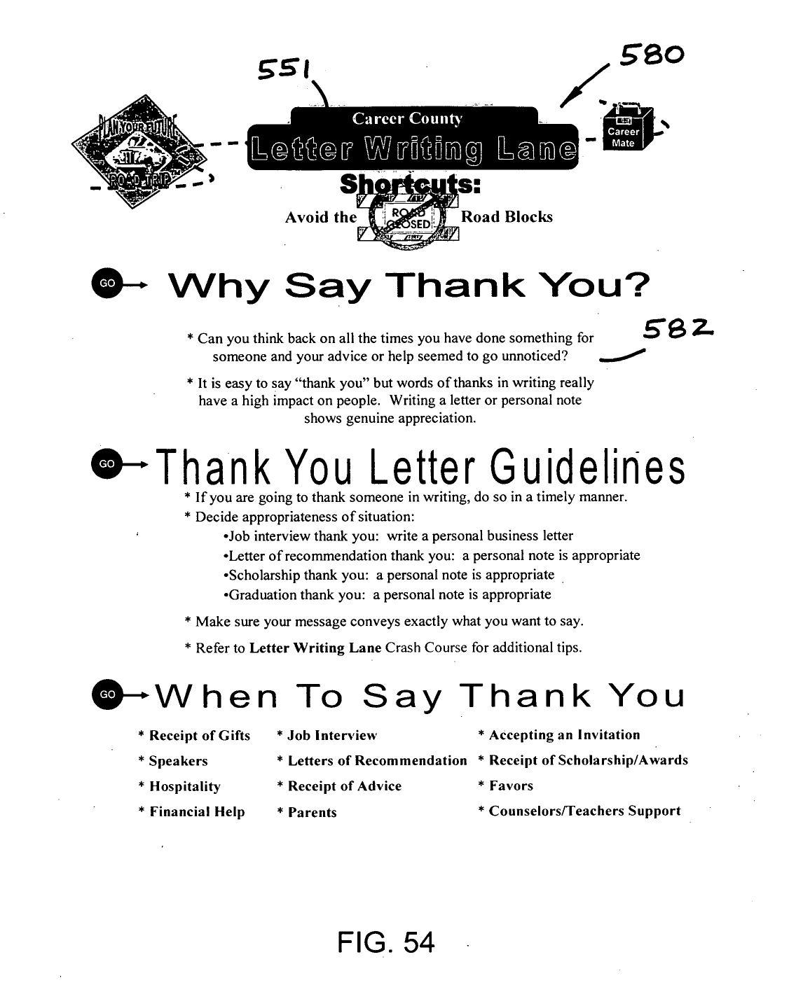

Referring now to FIGS. 51-54, the subject matter of writing well-composed letters is address by taking the user to “Letter Writing Lane” in “Career County” 551, which is depicted by displays 550, 560, 570, 580. The first display 550 is another three-step “Crash Course” 552 that includes a first section 553 in which the student learns why a good letter is important and when the student needs to write a letter. A second section 554 provides the student with the elements of a good letter and a third section 556 includes “Rules of the Road” for writing good letters. The related display 560 includes “Shortcuts” 562 with guidelines for writing a good personal business letter. The related display 570 provides the user with additional “Shortcuts” 572 with guidelines for writing a good personal letter. Finally, the last related display 580 provides the user with “Shortcuts” 582 with recommendations and guidelines for generating a “thank you” letter.

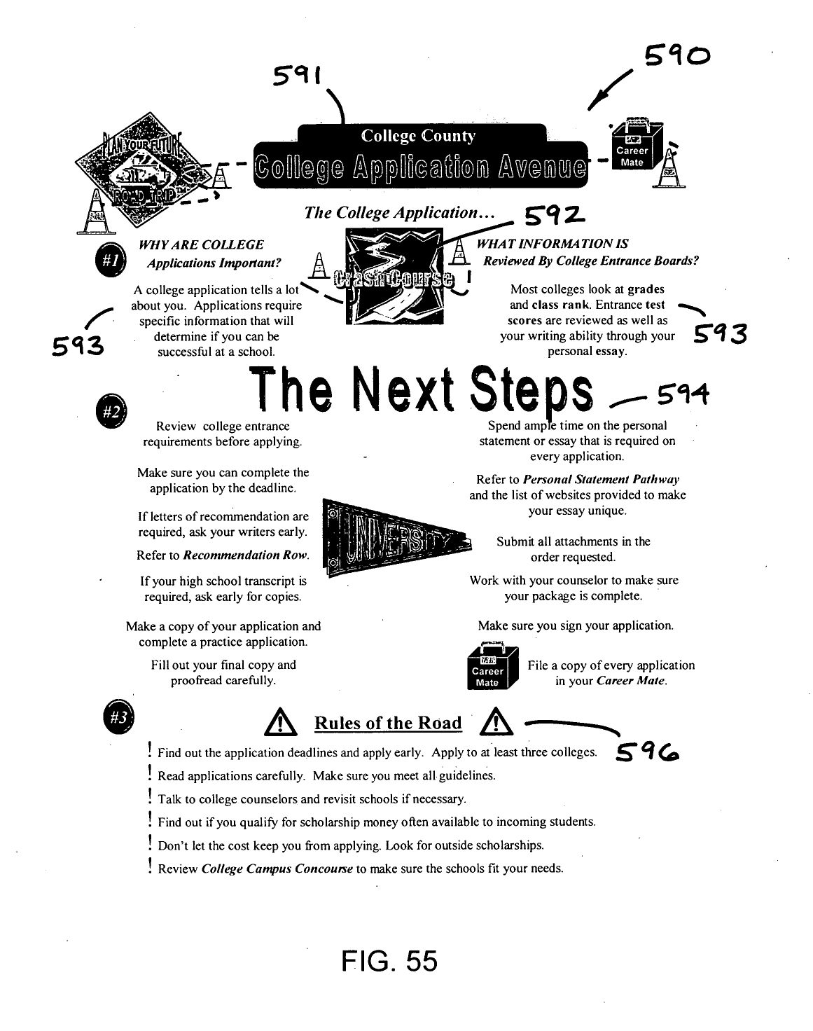

FIG. 55 includes a display 590 that instructs the user on the subject of college applications at “College Application Avenue” which is located in “College County” 591. This display 590 is a “Crash Course” 592 as to why college applications are important and what information is reviewed by the college entrance boards who review the applications. It specifically asks and answers the questions, “Why are college applications important?” and “What information is reviewed by college entrance boards?” 593. The display 590 identifies 594 the “Next Steps” in the process and includes “Rules of the Road” 596 to be considered by the student and user relative to such applications.

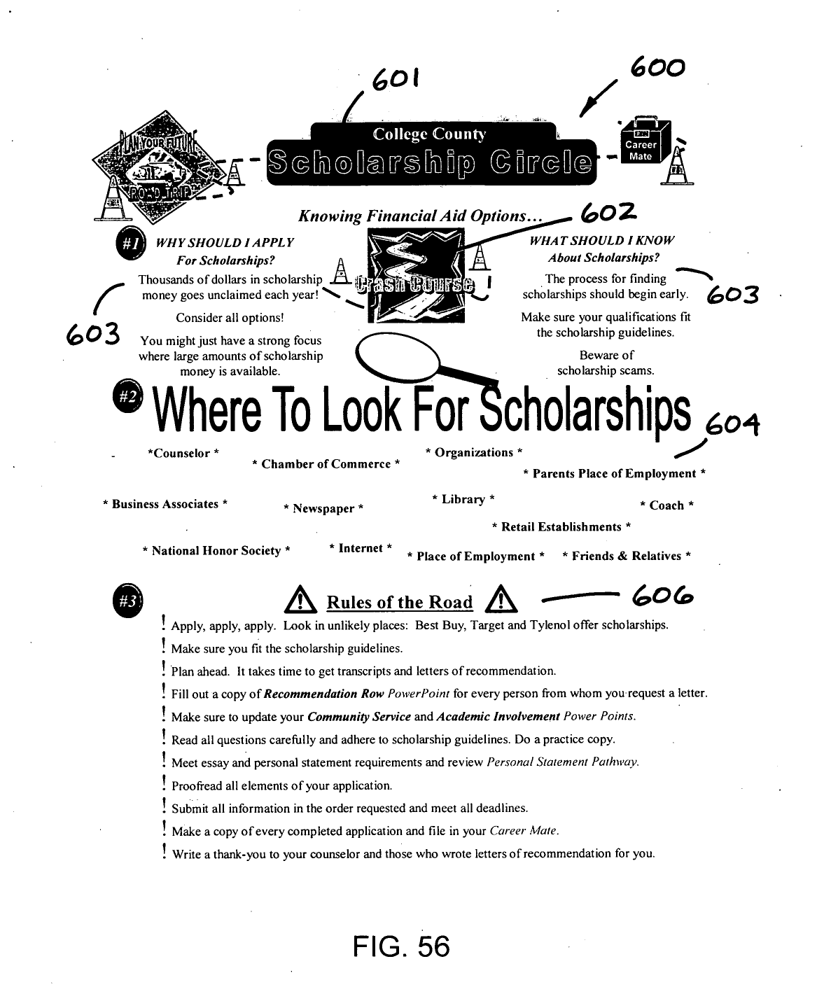

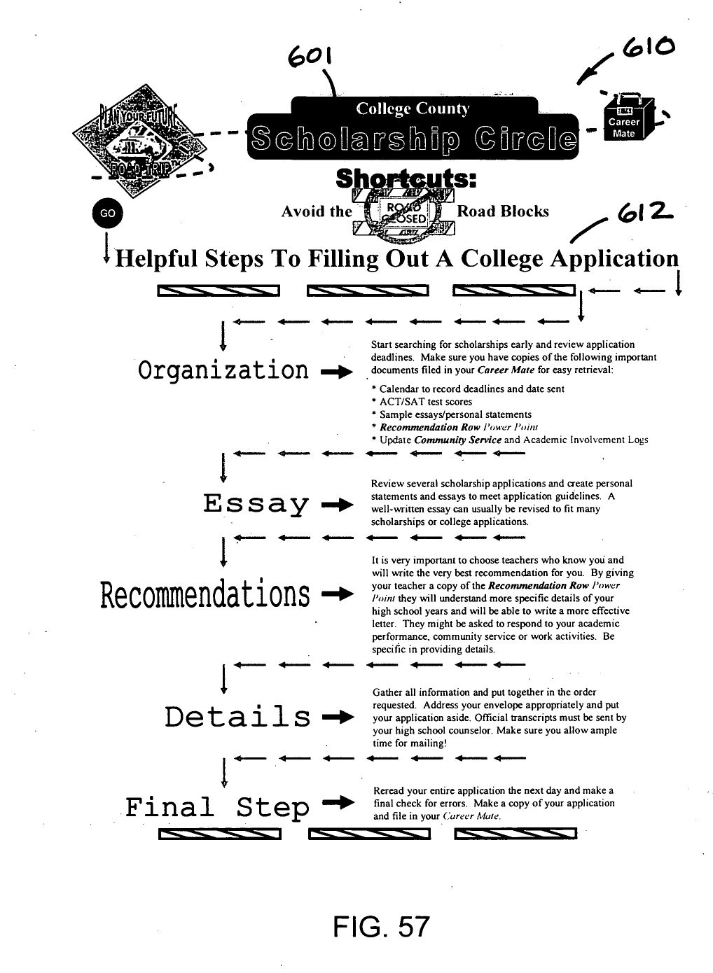

FIG. 56 includes a display 600 that instructs the user on the subject of applying for scholarships at “Scholarship Circle” which is located in “College County” 521. This display 600 is a “Crash Course” 602 on the subject of financial aid and it asks and answers the questions, “Why should I apply for scholarships?” and “What should I know about scholarships?” 603. The display 600 identifies 604 places that the student can look for available scholarship sources and includes “Rules of the Road” 606 to be considered by the student and user. The related display 610 is illustrated in FIG. 57 and provides “Shortcuts” 612 in the form of helpful steps to filling out a college application.

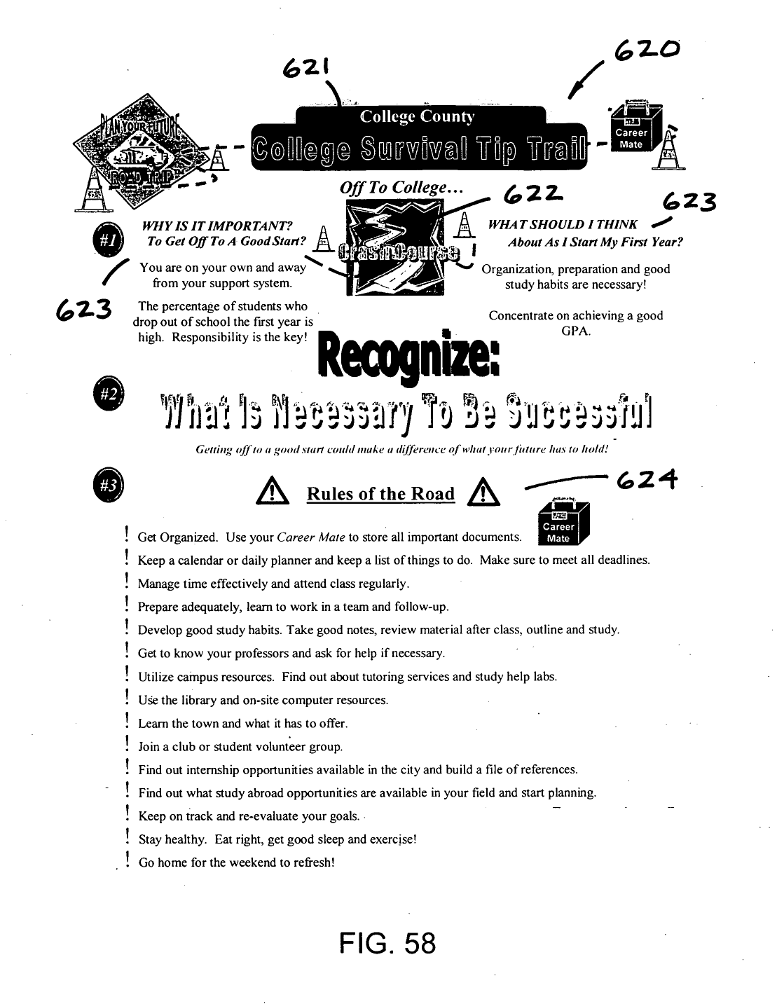

FIG. 58 includes a display 620 that informs the user about surviving at college at “College Survival Tip Trail” which is also located in “College County” 621. This display 620 is a “Crash Course” 622 on items to be considered in preparing to go off to college. It asks and answers the questions, “Why is it important to get off to a good start?” and “What should I think about as I start my first year?” 623. The display 620 includes “Rules of the Road” 624 to be considered by the student as he or she prepares for the start of his or her college career.

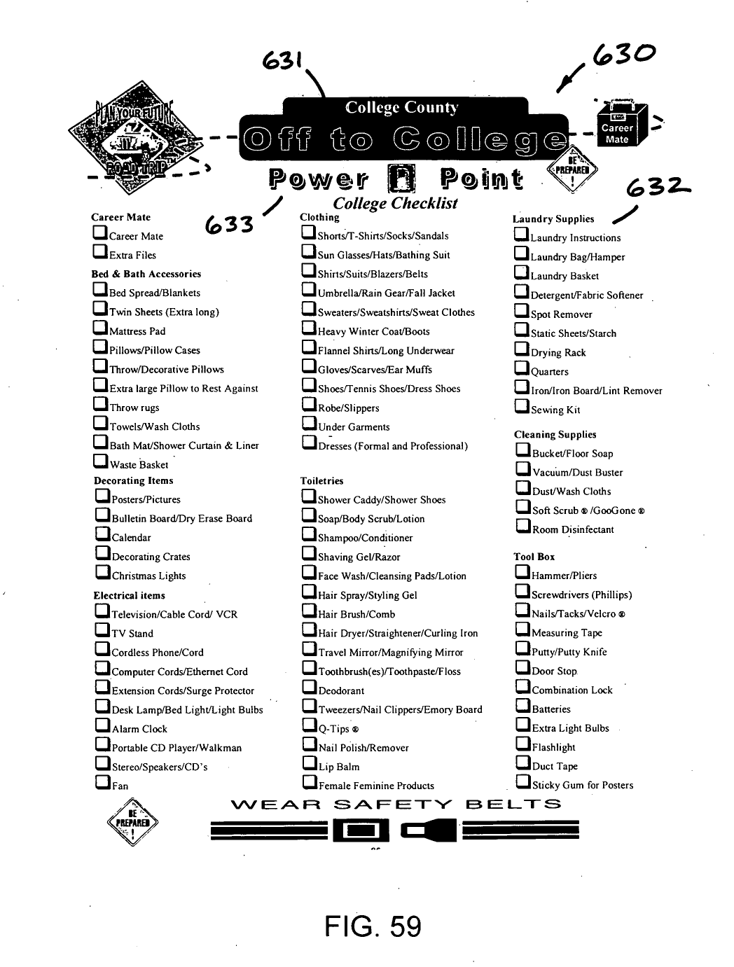

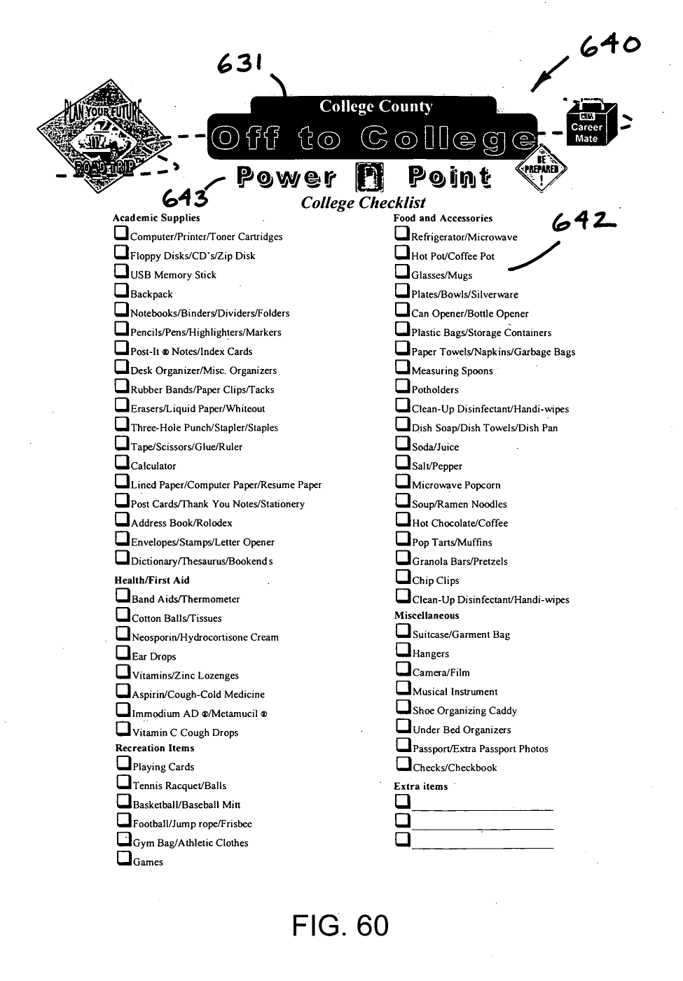

Finally, FIGS. 59 and 60 include displays 630, 640, respectively, that include a comprehensive “College Checklist” 632, 642 of items to be taken with the student as he or she heads off for college. By road map analogy, these displays 630, 640 are located at a road called “Off to College” which is located in “College County” 631. Each display 630, 640 is also formatted as a “Power Point” 633, 643 and reminds the user to file all completed “Power Points” in his or her “Career Mate” 300 for safe-keeping and future reference.

Based on the foregoing, it will be apparent that there has been provided a new, useful and non-obvious method and system that comprises a self-directed, easy-to-follow guide for parents, teachers, mentors and students to help students get a successful start as they begin their journey in life; that has as its key components documentation and filing which are interestingly and usefully combined with a way to understand the educational process, all of which helps students successfully plan for the future. This new method and system includes a planning guide to help students develop life skills. It also includes instructions for preparing important documents and a way of storing and updating information retained by the user.

The principles of this invention having been fully explained in connection with the foregoing, I hereby claim as my invention:

1. A method for acquiring and storing personal educational or vocational information which comprises the steps of
providing a first plurality of two-dimensional displays, each display in the first plurality of displays containing one or more summaries of useful information for a user,
wherein each display in the first plurality of displays informs the user about a certain category of information and why that information is important to the user,
providing a second plurality of two-dimensional displays, each display in the second plurality of displays containing one or more checklist displays,
wherein each display in the second plurality of displays prompts the user to complete the checklist contained therein, and
providing a pre-programmed scheme for systematically guiding the user through the first and second plurality of displays,
wherein the user is prompted to acquire and store certain personal educational or vocational information by electronic or other means.

2. The information acquisition and storage method of claim 1 wherein said pre-programmed guiding scheme is formatted to effect a road map-like representation for guiding the user through the displays.

3. The information acquisition and storage method of claim 2 wherein various of the displays are presented with road and county analogies for the purpose of systematically guiding the user through the displays.

4. The information acquisition and storage method of claim 3 wherein the road and county analogies are the same for displays that relate to like subject matters.

5. The information acquisition and storage method of claim 1 wherein said pre-programmed guiding scheme is formatted to effect a road map-like representation for guiding the user through displays that relate to a specific high school grade levels.

6. The information acquisition and storage method of claim 5 wherein various of the displays are presented with road and county analogies for the purpose of systematically guiding the user through the displays and through specific high school grade levels.

7. The information acquisition and storage method of claim 6 wherein the road and county analogies are the same for displays that relate to like subject matters within specific high school grade levels.

8. The information acquisition and storage method of claim 7 wherein certain road map-like shortcuts are used within certain displays to present information to the user in an abbreviated form.

9. The information acquisition and storage method of claim 8 wherein certain displays prompt the user to generate specific documents, to prepare a storage structure having files with certain organizational headings for storage of the acquired information or generated documents within them, and then storing the acquired information or documents within the files contained within the structure.

10. A system for acquiring and storing personal educational or vocational information which comprises
a first plurality of two-dimensional displays, each display in the first plurality of displays containing one or more summaries of useful information for a user,
wherein each display in the first plurality of displays informs the user about a certain category of information and why that information is important to the user,
a second plurality of two-dimensional displays, each display in the second plurality of displays containing one or more checklist displays,
wherein each display in the second plurality of displays prompts the user to complete the checklist contained therein, and
a pre-programmed scheme for systematically guiding the user through the first and second plurality of displays,
wherein the user is prompted to acquire and store certain personal educational or vocational information by electronic or other means.

11. The information acquisition and storage system of claim 10 wherein said pre-programmed guiding scheme is formatted to effect a road map-like representation for guiding the user through the displays.

12. The information acquisition and storage system of claim 11 wherein various of the displays are presented with road and county analogies for the purpose of systematically guiding the user through the displays.

13. The information acquisition and storage system of claim 12 wherein the road and county analogies are the same for displays that relate to like subject matters.

14. The information acquisition and storage system of claim 10 wherein said pre-programmed guiding scheme is formatted to effect a road map-like representation for guiding the user through displays that relate to a specific high school grade levels.

15. The information acquisition and storage system of claim 14 wherein various of the displays are presented with road and county analogies for the purpose of systematically guiding the user through the displays and through specific high school grade levels.

16. The information acquisition and storage system of claim 15 wherein the road and county analogies are the same for displays that relate to like subject matters within specific high school grade levels.

17. The information acquisition and storage system of claim 16 wherein certain road map-like shortcuts are used within certain displays to present information to the user in an abbreviated form.

18. The information acquisition and storage system of claim 17 wherein certain displays prompt the user to generate specific documents, to prepare a storage structure having files with certain organizational headings for storage of the acquired information or generated documents within them, and then storing the acquired information or documents within the files contained within the structure.
